(19) United States
(12) Patent Application Publication
(10) Pub. No.: US 2024/0402211 A1
(43) Pub. Date: Dec. 5, 2024

(54) LOCATION MEASUREMENT TECHNIQUES

(71) Applicant: Apple Inc., Cupertino, CA (US)

(72) Inventors: Jonathan R. Schoenberg, Fishers, IN (US); Yoav Feinmesser, Tel Aviv (IL); Alexander Singh Alvarado, San Jose, CA (US); Evan G. Kriminger, San Francisco, CA (US); Jonathan M. Beard, San Jose, CA (US); Hollie R. Figueroa, Cupertino, CA (US); Eyal Waserman, Netanya (IL); Rafi Vitory, Herzliya (IL); Ron Eyal, Herzliya (IL); Yunxing Ye, Fremont, CA (US)

(73) Assignee: Apple Inc., Cupertino, CA (US)

(21) Appl. No.: 18/677,583

(22) Filed: May 29, 2024

Related U.S. Application Data
(60) Provisional application No. 63/470,675, filed on Jun. 2, 2023.

(51) Int. Cl. G01P 13/00; G06F 3/16

(52) U.S. Cl. CPC G01P 13/00; G06F 3/165

(57) ABSTRACT

In some implementations, responsive to a trigger signal at an associated first time, a mobile device generating a first location value using a first ranging session with one or more other devices. The technique may include storing the first location value in a memory. The technique may include tracking, using a motion sensor of the mobile device, motion of the mobile device to determine a present location relative to the first location value. Further, the technique may include determining that a present location for the mobile device has changed by a predetermined threshold amount from the first location value since the associated first time. Responsive to the present location for the mobile device having changed by more than the predetermined threshold amount since the associated first time, the technique may include, generating a second location value using a second ranging session with the one or more other devices.

### CROSS-REFERENCES TO OTHER APPLICATIONS

This application claims priority to U.S. Provisional Application No. 63/470,675, for “LOCATION MEASUREMENT TECHNIQUES” filed on Jun. 2, 2023, which is herein incorporated by reference in its entirety for all purposes.

### BACKGROUND

Mobile devices can use several different sensors for accurate navigation. These sensors can be used to determine a position of the mobile device even when indoors or when Global Navigation Satellite Systems (GNSS) information is unavailable. However, some of these different sensors can incur a processing time penalty when calculating the position of the mobile device from the sensor information. This processing time can result in undesirable delays in loading applications and can result in a poor user experience when using these mobile device applications. Further, it is desirable for the mobile device to proactively maintain a balance between navigation sensor use and battery energy conservation.

Augmented Reality (AR) applications may experience lag upon activation due to the determination of the position of the mobile device with respect to augmented reality areas. Traditional ranging services can be time consuming and can result in inefficient use of battery resources. The lag in determining a position of the device can result in poor user experience.

Thus, improvements to determining whether or not an updated RF scan is required because of movement of the mobile device are desired.

### SUMMARY

Embodiments provide techniques for determining a location of a mobile device even when the mobile device is indoors. The techniques allow for determining when to update the location of the mobile device and balance sensor use in ranging sessions with energy conservation for a battery of the mobile device. The techniques can use motion sensors to determine when to determine update a location of the mobile device, e.g., using ranging techniques. In addition, the techniques can be used with augmented reality (AR) techniques. AR techniques can have determined AR areas in which sensors of the mobile device can be used to precisely determine a position of the mobile device. The techniques can determine when the trajectory of the mobile device indicates that the mobile device will enter and/or leave AR areas.

As one example, a device can integrate a motion sensor feature to determine if the device has moved significantly (e.g., greater than a threshold) since it was last used. Such motion sensor techniques can be performed in a background mode, even if the device is in standby mode (e.g., screen is off, or the main application is in a rest mode) with minimal power usage. The motion sensor feature can determine if the mobile device has moved by a predetermined amount that would trigger ascertaining the device's location again using a subsequent ranging session.

As another example, the mobile device can determine a location of the mobile device in a background mode. The mobile device can determine if the mobile device is within an augmented reality area or on a trajectory for an augmented reality area. If it is determined that the mobile device is on a trajectory for an augmented reality area, the augmented reality application can be preloaded into to memory to reduce the lag. If the mobile device is within an augmented reality area the mobile device can prompt a user if the augmented reality application should be initiated.

Other embodiments are directed to systems, portable consumer devices, and computer readable media associated with methods described herein.

A better understanding of the nature and advantages of embodiments of the present disclosure may be gained with reference to the following detailed description and the accompanying drawings.

### BRIEF DESCRIPTION OF THE DRAWINGS

FIG. 1A is a simplified diagram illustrating clusters of physical positions in physical space.

FIG. 1B is a simplified diagram illustrating clusters of sensor positions in sensor space corresponding to the physical positions in physical space of FIG. 1A.

FIG. 2A is a flowchart of a method for generating clusters of sensor positions.

FIG. 2B is a flowchart of a method for identifying an application based upon a sensor position.

FIG. 3 shows a block diagram of a system for determining a triggering event.

FIG. 4 shows a block diagram of a system for identifying an application or playback device for a user based on a sensor position.

FIG. 5 illustrates a first exemplary environment for determining a location of a mobile device.

FIG. 6 illustrates a second exemplary environment for determining a location of a mobile device.

FIG. 7 illustrates a flow chart for a process for determining when to update a location of a mobile device according to some embodiments.

FIG. 8 illustrates a third exemplary environment for demonstrating an exemplary use case for an updated position of a mobile device.

FIG. 9 is a flowchart of a method for determining a location for a mobile device according to some embodiments.

FIG. 10 illustrates an exemplary AR map according to some embodiments.

FIG. 11 illustrates a first map of one potential use of predictive dead reckoning (PDR) and geo-fences for augmented reality (AR) applications.

FIG. 12 illustrates a second map of a potential use of PDR and geo-fence for AR applications.

FIG. 13 illustrates a third map of a residence for AR applications.

FIG. 14 is a flow chart of a process for using positioning techniques to determine when an electronic device trajectory is predicted to enter an Area of Interest (AOI) according to some embodiments.

FIG. 15 illustrates a simplified block diagram of a mobile device obtaining a fingerprint at a first time period according to various embodiments.

FIG. 16 illustrates a simplified block diagram of a mobile device obtaining a fingerprint at a second time period according to various embodiments.

FIG. 17 is a swim lane diagram depicting techniques for detecting device proximity according to some embodiments.

FIG. 18 is a swim lane diagram depicting techniques for detecting device proximity at a server device according to some embodiments.

FIG. 19 is a simplified block diagram illustrating an example architecture of a system used to detect device proximity at a mobile device according to some embodiments.

FIG. 20 is a simplified block diagram illustrating an example architecture of a system used to detect device proximity at a server device according to some embodiments.

FIG. 21 is a flowchart of a method for providing a proximity classification according to some embodiments.

FIG. 22 is a block diagram of an example device, which may be a mobile device, according to some embodiments.

### DETAILED DESCRIPTION

A ranging feature can determine a user's location within the home. However, there may be a limited budget (e.g., power or transmitter/receiver cycles) for doing radio frequency (RF) scans that can be used to update the range values. Techniques can be determined to utilize the limited budget as efficiently as possible. It would be undesirable to waste any ranging cycles to determine that a user device is in the same place that it was located at for the last time the range values were determined. In addition, it would be desirable for the device to have very low latency such that when a user unlocks their device and launches into a media application (App) to be able to quickly surface recommendations for a playback device when that App comes to the forefront.

An “application” (or App) can be a client software program that is executed by a processor of a device (e.g., executed within an operating system), or can be provided as a part of an operating system, or be provided by third party developers and downloaded to the device. An application may be a specific part of the operating system designed to perform a specific function when executed by a processor. An application can stream media content (e.g., audio and/or video content) to another device. For example, the music application can stream music to one or more speakers that can communicate with the mobile device. An application (e.g., home application) on a mobile device may be used to control other devices, such as accessory devices (e.g., kitchen appliances, lightings, thermostat, smart locks on doors, window shades, etc.), throughout a home. A user of the home application may be in the same room as the accessory device that is controlled or may be in a different room from the accessory device that is being controlled. For example, a user may be in their kitchen when they use the home application on their mobile device to close the garage door.

An “accessory device” can be a device that can be controlled remotely. The accessory device may be in the vicinity of a particular environment, region, or location, such as in a home, apartment, or office. An accessory device can include a garage door opener, door locks, fans, lighting device (e.g., lamps), a thermometer, windows, window blinds, kitchen appliances, and any other devices that are configured to be controlled by an application, such as a home application. An accessory device can be determined or associated with a home by the home application. An accessory device can be determined by, for example, a mobile device automatically scanning an environment for any accessory devices, or a user may manually enter accessory device information via, for example, the home application.

Users often perform the same or repeated actions with accessory devices while in a particular location. For example, every time a user comes home from work, they may close the garage door when they are in the kitchen. In addition, when it is dark outside, the user may turn on a lamp in the living room or change the temperature on a thermostat while in the living room. Therefore, certain activities with respect to devices in a home may be performed regularly and repeatedly (e.g., daily, several times throughout a day) while the user is in a certain location. In another example, a user may choose to stream video content to a living room smart TV when sitting on the couch in the living room. It can be a time consuming and tedious task for a user to work through various user interfaces to perform these tasks since these tasks are performed regularly or several times throughout the day.

Embodiments provide improved mobile devices and methods for recommending applications and/or accessory devices, or automatically performing an action with the application based on historical usage of the application at identifiable locations (which may be referred to as microlocations) using sensor measurements. Sensor(s) on the mobile device (e.g., an antenna and associated circuitry) can measure sensor values from wireless signals emitted by one or more signal sources that are essentially stationary, e.g., a wireless router in the home or a network enabled appliance. These sensor values are reproducible at a same physical position of the mobile device, and thus the sensor values can be used as a proxy for physical position. In this manner, the sensor values can form a sensor position, although in sensor space, as opposed to physical space. A “sensor position” may be a multi-dimensional data point defined by a separate sensor value for each dimension. In various embodiments, a parameter of a wireless signal can be a signal property (e.g., signal strength or time-of-flight, such as round-trip-time (RTT)), or other sensor values measured by a sensor of a mobile device, e.g., relating to data conveyed in the one or more wireless signals.

### I. Sensor Measurements and Clusters

While a mobile device is positioned at a physical location within a dwelling (e.g., a home or building) or other location region, the mobile device can detect a triggering event and then measure signals emitted from one or more signal sources existing at that point in physical space. For instance, the mobile device may detect a button press, which acts as a triggering event and causes the mobile device to measure signals (e.g., Wi-Fi, Bluetooth (BT), Bluetooth Low Energy (BLE), ultrawideband (UWB), Zigbee, etc.) emitted from any signal source, e.g., electronic devices, such as a wireless router, a Wi-Fi equipped appliance (e.g., set top box, smart home device), or a Bluetooth device. The detected signals may be used to generate a multi-dimensional data point of sensor values in sensor space, where each dimension in sensor space can correspond to a property of a signal emitted from a signal source. The multi-dimensional data point may represent the sensor position of the mobile device in sensor space, where the sensor position corresponds to the physical position of the mobile device in physical space.

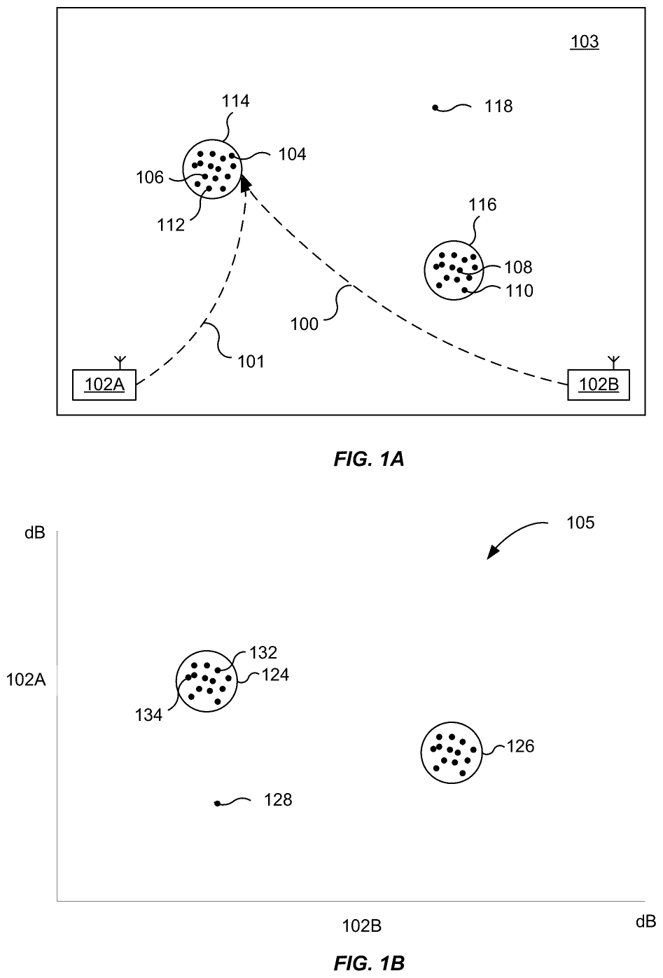

FIG. 1A is a simplified diagram illustrating a plurality of physical positions in physical space 103. As examples, physical space 103 can be the interior of a home, an office, a store, or other building. Physical space 103 may include a plurality of signal sources, such as signal sources 102A and 102B. Each signal source can emit wireless communication signals, as are emitted from a wireless router or a Bluetooth device. A signal source can be considered a stationary device, as their position does not typically change.

A “cluster” corresponds to a group of sensor positions (e.g., scalar data points, multi-dimensional data points, etc.) at which measurements have been made. Sensor positions can be determined to lie in a cluster according to embodiments described herein. For example, the sensor positions of a cluster can have parameters that are within a threshold distance of each other or from a centroid of a cluster. When viewed in sensor space, a cluster of sensor positions appears as a group of sensor positions that are close to one another. A cluster of sensor positions can be located, for example, in a room of a house or in a particular area (e.g., hallway, front door area) of a house.

A specified location in a house or building can also be referred to as a “microlocation.” A location can be referred to as a microlocation because the location refers to a specific area in, for example, the user's home. In addition, a location or microlocation can also be referred to as a cluster of locations. The following terms: location, microlocation, and cluster of locations may refer to a same area or region. A home may have a number of locations. A location can correspond to a room in a house, a portion of a room, or other areas in a house. For example, a location can be a backyard area, a front door area or a hallway area.

A mobile device may be located within physical space 103 such that one or more signals emitted from signal sources 102A and 102B are detected. For example, the mobile device may be located at physical position 104 in FIG. 1A, where signals 101 and 100 are detected from signal sources 102A and 102B, respectively. It is to be appreciated that the mobile device may only measure one of signals 101 and 100 at some positions, e.g., due to signal degradation at certain positions. Furthermore, the mobile device can be at a physical position where signals from other signal sources (not shown) that are outside of physical space 103 can be detected, and that techniques herein are not limited to physical positions where the mobile device can only detect signals 101 and 100.

Typical human behavior results in the mobile device being used in some physical locations more often than other physical locations. For example, a user may use a mobile device more often when the user is on a couch or in a bed. These physical locations may be represented by clusters of physical positions, such as clusters 114 and 116 of physical positions. Each cluster may have a group of physical positions that are located close together. As an example, cluster 114 may include physical positions 104, 106, and 112. As shown, cluster 116 includes physical positions 108 and 110. The mobile device may be configured to determine when the mobile device is in one of these clusters based on the detected signals (e.g., signals 100 and 101) and identify an application that is associated with the cluster.

As part of detecting signals at any of the physical positions using sensor(s) of the mobile device, the mobile device may measure one or more sensor values from signals emitted from signal sources 102A and 102B. For instance, if the mobile device is at physical position 104, the mobile device may measure sensor values from signal 101 emitted from signal source 102A and signal 100 from signal source 102B. The measured sensor values may be signal properties of signal 101 and signal 100. The measured sensor values may be used to form a sensor position in sensor space, as shown in FIG. 1B.

FIG. 1B is a simplified diagram illustrating a plurality of sensor positions in sensor space 105, which corresponds to physical space 103. Sensor space 105 is depicted as a plot of measured sensor positions in signal strength. The X axis may represent measured values of signals from signal source 102B in dB increasing to the right, and the Y axis may represent measured values of signals from signal source 102A in dB increasing upwards. Although FIG. 1B illustrates an example in which the sensor space has two dimensions (e.g., sensor values from signals from signal source 102A and signal source 102B, respectively), a sensor space can include more or fewer dimensions.

The sensor positions in sensor space correspond to respective physical positions in physical space 103. For example, measured sensor values at physical position 104 in FIG. 1A corresponds to a sensor position 132 in sensor space shown in FIG. 1B. Sensor position 132 is represented as a two-dimensional data point where one dimension corresponds to a sensor value from signal source 102A and the other dimension corresponds to a sensor value from signal source 102B. Sensor space 105 may include clusters of sensor positions, e.g., cluster 124 of sensor positions and cluster 126 of sensor positions. Clusters 124 and 126 of sensor positions correspond with clusters 114 and 116 of physical positions in FIG. 1A, respectively.

Clusters 124 and 126 may be unlabeled locations, meaning the mobile device does not know the actual physical coordinates corresponding to clusters 124 and 126. The device may only know that there exists a cluster of sensor positions that have similar sensor values and that the cluster represents a discrete location in physical space. However, the mobile device may perform functions based on sensor positions in sensor space such that use of the mobile device in physical space is benefitted. For instance, the mobile device may determine a sensor position of the mobile device and suggest an application to the user based on whether the sensor position is within a cluster in which pattern of application usage is known. Method of forming clusters and suggesting an application according to a sensor position are further discussed below.

Accordingly, a sensor position can correspond to a set of one or more sensor values measured by sensor(s) of a mobile device at a physical position in physical space from one or more wireless signals emitted by one or more signal sources (e.g., external devices such as networking devices). A sensor value can be a measure of a signal property, e.g., signal strength, time-of-flight, or data conveyed in a wireless signal, as may occur if a signal source measures a signal property from the mobile device and sends that value back to the mobile device. Each sensor value of a set can correspond to a different dimension in sensor space, where the set of one or more sensor values forms a data point (e.g., a multi-dimensional data point, also called a feature vector) in the sensor space.

In the example shown in FIG. 1A, sensor values for sensor positions in cluster 114 may be higher for signal source 102A (which is in the vertical axis in FIG. 1B) than the sensor values for sensor positions in cluster 116, e.g., when the sensor value is signal strength. This may be due to the fact that physical positions in cluster 114 are closer to signal source 102A than physical positions in cluster 116 are to signal source 102A. When the sensor value is a signal property of time-of-flight, the values for cluster 114 would be smaller than for cluster 116.

A given measurement of the one or more wireless signals obtained at a physical position may be made one or more times over a time interval to obtain a set of sensor value(s). Two measurements at two different times can correspond to a same sensor position, e.g., when the two measurements are made at a same physical position at the two different times. A sensor position can have a value of zero for a given dimension, e.g., if a particular wireless signal is not measured, or have a nominal value, e.g., in case of low signal power (−100 decibels (dB) received signal strength indication (RSSI)) or have an uncertainty that is large.

Groups of sensor positions having similar parameters may form a cluster, which can be used to define a discrete location. One or more clusters may be used to identify an application or an accessory device to suggest to a user in, for example, a message (e.g., display on a screen or an audio message).

Applications and/or accessory devices can be associated with the one or more clusters. Specifically, applications and accessory devices can be associated with a particular location of the mobile device. A location that refers to a specific area in a user's home can be referred to as a microlocation. A microlocation can also be referred to as a cluster of locations. The following terms: location, microlocation, and cluster of locations may refer to a same area or region. A location can correspond to a room in a house or other areas in a house. For example, a location can be a backyard area, a front door area or a hallway area. Although a home is used as an example, any area or room in which accessory devices are located can be used in determining a cluster of locations.

II. Predicting User Interaction with a Device

The mobile device may identify which applications (or accessory devices) are run by the user at each sensor position. After collecting sensor positions and corresponding applications run by the user at the sensor positions, the device may generate clusters of sensor positions (e.g., periodically at night) and associate one or more applications that are likely to be run by the user with the clusters of sensor positions. Accordingly, when a subsequent triggering event is detected, the device may generate a new sensor position and compare the new sensor position to the generated clusters of sensor positions. If the new sensor position is determined to be within a threshold distance to one of the clusters of sensor positions, one or more applications associated with that cluster of sensor positions may be identified and used in an action, e.g., provided to the user as a suggested application. The threshold distance may be a distance represented in units of decibels (e.g., for received signal strength indication (RSSI)) or meters (e.g., for time-of-flight (TOF)), depending on the units of the sensor position, as will be discussed further herein. The mobile device may use the location information to determine a relevant playback device of a plurality of playback devices at a location. In various embodiments, the mobile device can use the location information to trigger activation or deactivation of one or more sensors as the mobile device enters or leaves an augmented reality (AR) area.

### A. Learning and Generating Clusters

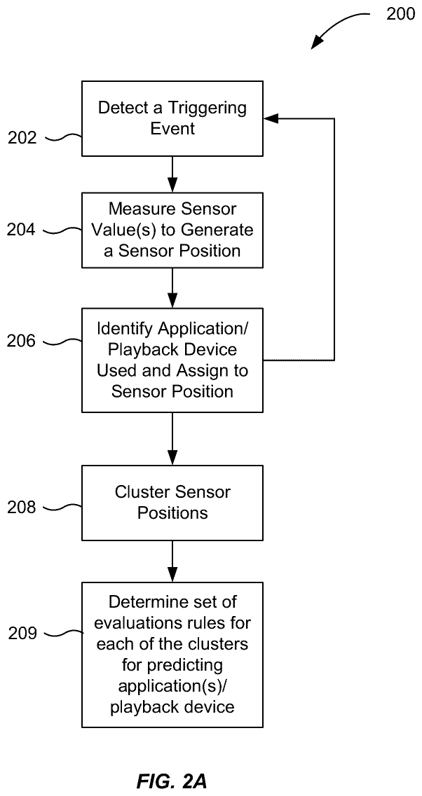

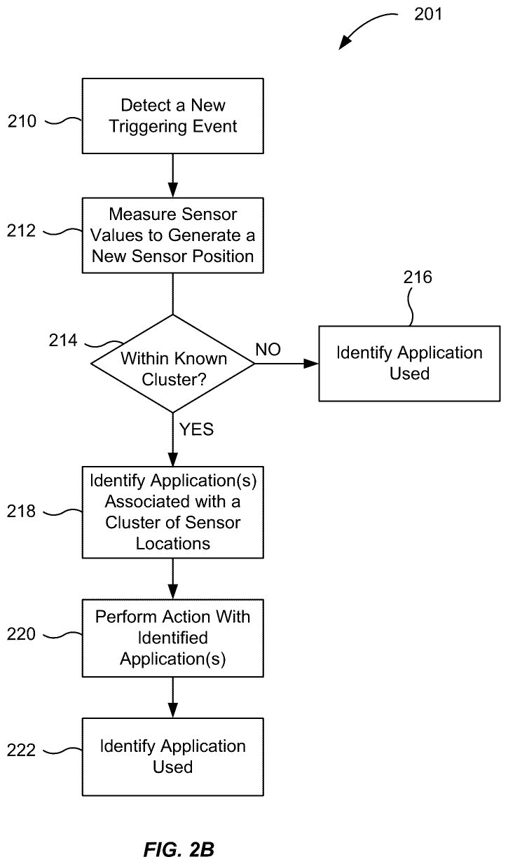

FIG. 2A is a flowchart of a method 200 for generating clusters of sensor positions. The clusters of sensor positions may be later used by a mobile device to identify and suggest an application to a user. The cluster of sensor positions can also be used to recommend a playback device for streaming media (e.g., video or audio) to a relevant playback device based on the microlocation. Method 200 can be performed by a mobile device, e.g., a phone, tablet, wearable computing device, and the like.

At block 202, a triggering event is detected. A triggering event can be identified as an event sufficiently likely to correlate to an operation of the mobile device. A triggering event can be caused by a user and/or an external device. For instance, the triggering event can be a specific interaction of the user with the mobile device. In various embodiments, the triggering event can be when the mobile device is stationary for longer than a specified period of time as determined by one or more motion sensors (e.g., an IMU). The specific interaction can be used to learn what the user does at a particular position, and thus can be considered a learning triggering event. Examples of learning triggering events are application launches, specific activity within an application (e.g., making a selection within the application), voice commands (e.g., to initiate at voice assistant to perform searching or other activity with an application), and a first interaction of the day. As other examples, a triggering event can be when an accessory device is connected to the mobile device, e.g., inserting headphones into a headphone jack, making a Bluetooth connection, and the like. A list of events that are triggering events can be stored on the mobile device. Such events can be a default list and be maintained as part of an operating system and may or may not be configurable by a user.

At block 204, one or more sensor values can be measured by one or more sensors of the device to generate a sensor position (e.g., sensor position 132 in FIG. 1A) in the form of a data point (e.g., a multi-dimensional data point or a single-dimensional data point). The sensor position is measured at a physical position in physical space. The sensor values may correspond to one or more signal properties of a signal (e.g., signals 100 and 101 in FIG. 1A) emitted from one or more signal sources (e.g., signal sources 102A and 102B in FIG. 1A). For example, the sensor values may be values corresponding to signal strengths of measured signals, such as received signal strength indication (RSSI) values or any other suitable signal property whose value changes with respect to a distance of separation from a signal's point of origin. In other cases, the sensor values may include signal properties indicative of a distance between the device and the signal's point of origin, such as a time-of-flight (TOF) measurement value. As an example, the one or more sensors can include one or more antennas and associated circuitry to measure properties of a signal. Other examples of sensors can include light sensors or audio sensors.

A signal source may be any suitable device configured to emit wireless signals. For example, a signal source may be an access point such as a wireless router, a Bluetooth device, or any other networking device suitable to transmit and/or receive signals (e.g., Bluetooth speakers, refrigerators, thermostats, home automation portals, etc.). Different signal sources can be identified based on an identifier in the signal. Each measurement from a different device can correspond to a different sensor value.

Even if a signal from only one signal source is measured, the data point representing the location can still have multiple dimensions. For example, multiple measurements can be made of signals from the same signal source, with each measurement corresponding to a different dimension of the data point (e.g., measurements of different signal properties of the signal). Additional dimensions can correspond to other devices, even if signals are not detected at a given location. Non-detected devices can have a sensor value of zero assigned, thereby still having a value for those dimensions.

At block 206, the device can identify an application used at the time the sensor value(s) are measured. The identified application may be assigned to the corresponding sensor position. A correlation between a sensor position and an application may be determined when the application is used multiple times at the sensor position or nearby sensor positions (e.g., as part of a same cluster). This correlation can be used to predict which application the user will likely use when a given sensor position is measured.

In various embodiments, at 206, the device can identify a playback device of a plurality of playback devices in a location (e.g., a room). The mobile device may also use historical information to recommend a playback device of the plurality of playback devices. For example, a user may normally select the smart television to playback video media files when located in a couch in the living room. If the user selects a video media file for playback and is sitting on the couch, the mobile device will recommend the smart television for playback.

In various embodiments, the application can be an augmented reality application. As the mobile device enters an AR application area, the mobile device can activate one or more sensors of the mobile device.

An application may correspond to any software executed on a processor of a device. For example, an application can be a client application that is executed by an operating system (e.g., electronic recipe software or software to read electronic books). As another example, an application can be software that is part of the operating system (e.g., a daemon).

Once an application has been identified, method 200 may loop back and detect an occurrence of another triggering event at block 202. In which case, method 200 may once again measure sensor values to generate a sensor position at block 204 and identify another application used at the sensor position at block 206. Blocks 202, 204, and 206 may be performed many times to gather numerous recordings of various sensor positions and the associated applications.

At block 208, the numerous recordings of various sensor positions may be analyzed to form clusters of sensor positions. The sensor positions may be analyzed at night when the user is asleep or not planning on using the mobile device for an elongated period of time, e.g., at least 4 hours. The analysis may be a batch analysis performed on a plurality of sensor positions stored from use of the mobile device across several days or weeks. A cluster of sensor positions can correspond to a group of sensor positions that are near each other in sensor space. For example, the sensor positions of a cluster can have data points that are within a threshold distance of each other or from a centroid of a cluster. Sensor positions of a cluster in sensor space would typically have their corresponding physical positions form a cluster in physical space.

As shown in FIG. 1A, physical positions 104, 106, 108, and 110 may be grouped into clusters 114 and 116 based on having similar sensor values. As an example, physical positions 104 and 106 may be grouped within cluster 114 because the sensor values for physical position 104 are within a threshold distance to the sensor values for physical position 106. Likewise, physical positions 108 and 110 may be grouped within cluster 116 because the sensor values for physical position 108 may be within a threshold distance to the sensor values for physical position 110. However, sensor values for sensor positions in cluster 114 may be different than the sensor values for sensor positions in cluster 116, thereby resulting in a separation between clusters 114 and 116. The threshold distance may be defined by typical use of the device in physical space, e.g., widths of a few feet. A threshold distance in physical space can correlate to a sensor distance based on a mapping function that can be determined via a calibration process, which may be performed by a manufacturer of the mobile device. Further details of a threshold distance can be found in concurrently filed application entitled “Determining Location of Mobile Device Using Sensor Space to Physical Space Mapping,” which is incorporated by reference in its entirety.

Because the device has identified the application run by the device at the various sensor positions, one or more applications may be associated with each cluster of sensor positions. For example, if the user runs a food-related application at sensor position 132, then the food-related application may be associated with cluster 124. Cluster 124 may be associated with a physical location, such as a kitchen of a home (e.g., physical location 114). However, the device may not typically know the association between cluster 124 and the kitchen. The device may only know that cluster 124 is associated with the food-related application. Different applications may be associated with the same cluster, which may result in applications with different probabilities of being run by the user, where such probabilities can be used in determining an action to be performed with one or more of the applications, e.g., using a set of one or more evaluation rules.

At block 209, a set of one or more evaluations rules are optionally determined for each of the clusters based on historical interactions of a user with the mobile device. The evaluation rule(s) for a cluster can be determined based on how many times a particular application was run or a playback device was selected within that cluster, thereby determining which application(s) are run the most and potentially which actions are most likely to be performed by the application(s). In various embodiments, the clusters may correspond to AR areas. The evaluation rules can be optionally performed once the clustering is performed to minimize processing time when the clusters are used as part of determining a predicted application in response to a detected event. Alternatively, the evaluation rules can be performed at a later, e.g., when an event is detected. The determination can be made by a prediction model, as is discussed in more detail below.

### B. Performing Proactive Action Based on Measured Sensor Position and Clusters

Once the clusters have been determined and potentially after a prediction model has been run, the mobile device can be used in a mode that allows a predicted application to be identified based on measured sensor values. Even while predictions are made, sensor positions and associated application can be determined on an ongoing basis, with the clustering and any updates to a prediction model being performed periodically.

FIG. 2B is a flowchart of a method 201 for suggesting an application or a playback device to a user by referencing clusters of sensor positions. At block 210, a new triggering event is detected. Detection of the new triggering event may be similar to the detection of the triggering event discussed with reference to block 202 in FIG. 2A, but the new triggering event may occur at a later time and a different physical position. In various embodiments, the triggering event can be when the mobile device is stationary for longer than a specified period of time as determined by one or more motion sensors (e.g., an IMU). This new physical position may be in a cluster of physical positions corresponding to a cluster of previous sensor measurements.

In some cases, the new triggering event is a prediction triggering event, which is used to detect when to make a prediction of action that might be taken with an application on the mobile device, as opposed to just an event to learn what the user does. As an example, the user can press a button or touch a touch-sensitive display screen to cause a backlight of the mobile device to turn on, such as pushing a home button, thereby indicating that the user intends to interact with the mobile device. In such examples, the turning on of the backlight may be the triggering event. Other examples of triggering events include the user moving around substantially while on lock screen or home screen. Some prediction triggering events can also be learning triggering events.

At block 212, one or more sensor values are measured by the mobile device to generate a new sensor position. Generating the new sensor position may also be similar to generating the sensor position discussed with reference to block 204.

At block 214, it is determined whether the new sensor position is located within a known cluster of sensor positions. The new sensor position may be determined to be within a known cluster of sensor positions if it is within a threshold distance to a centroid of the known cluster of sensor positions. If the new sensor position is not within a known cluster of sensor positions, then at block 216, an application may be identified if an application is used in conjunction with the new triggering event. For example, a sensor position 128 corresponding to physical position 118 in FIG. 1A may not be within a threshold distance to clusters 124 or 126. Thus, the mobile device may record sensor position 128 and identify the associated application run by the user at sensor position 128 for future reference. But a specific action may not be taken, as a cluster had not been identified for that position.

If, however, the new sensor position is within a known cluster of sensor positions, then at block 218, an application corresponding to the known cluster is identified. If the new sensor position is positioned within a threshold distance to a cluster of sensor positions, then one or more applications associated with that cluster of sensor positions may be identified. The one or more applications may be determined using one or more evaluation rules that are generated at the time of measuring the sensor position or at a previous time, e.g., right after clustering.

As an example, referring back to FIG. 1A, physical position 112 may correspond with sensor position 134. Sensor position 134 may be positioned to be within a threshold distance to cluster 124. Accordingly, the application associated with cluster 124 may be identified for sensor position 134. If continuing with the example discussed with respect to block 208, the application identified for sensor position 134 may be the food-related application. As mentioned herein, the mobile device may not know that clusters 124 and 126 are associated with a physical location in a home, such as a kitchen or a bedroom. Rather, the mobile device may only know that the measured sensor positions form groups of sensor positions, as shown in FIG. 1B, and may associate each group of sensor position with a discrete location.

At block 220, an action is performed in association with the application. In various embodiments, the action can be streaming a media file (e.g., a video file, an audio file). In various embodiments, the action can be activating one or more sensors (e.g., inertial-optical sensors) for an AR application.

The action may be the providing of a message including or using the identified application, such as a notification including the application. For example, the message may be a user interface that allows a user to select to run the application. The user interface may be provided in various ways, such as by displaying on a screen of the mobile device, projecting onto a surface, or providing an audio interface. A particular user interface provided to the user may depend on a degree of probability of being performed by the user. For instance, the higher the probability of use (e.g., based on higher instances of such use), more aggressive action can be taken, such as automatically opening an application with a corresponding user interface (e.g., visual or voice command), as opposed to just providing an easier mechanism to open the application (e.g., an icon on lock screen). In some implementations, if a probability is too low for any application, then no action may be taken.

A “message” may correspond to data in any form of communication, which may be provided to a user (e.g., displayed) or provided to another device. A message can be generated by an application or include information related to an application running on a device (e.g., include a link to an application). As examples, a message may be an alert, notification, suggested application, and the like. A message does not necessarily have to include text that conveys a readable message, as the message can be to another application, and thus the message can be in binary form.

At block 222, an application is identified. The application may be the same application identified at block 218, thereby reinforcing the identification of the application and the action taken, or a different application run by a user, e.g., even after the message is provided to the user. Thus, even if the sensor position is within a cluster, an identification can be made of an application used, as further iterations of clustering and updating of evaluation rules of a prediction model can be performed on an ongoing basis. The performance of block 222 is an example of a prediction triggering event also being used as a learning triggering event. Alternatively, block 222 may be performed in response to a different learning triggering event (e.g., an application launch as opposed to a home button press), where the new sensor position can be re-used, as opposed to performing a new measurement.

Method 201 can enable a mobile device to accurately predict an application for a user at specific locations within a place where location information (e.g., information from GPS, Global Navigation Satellite System (GLONASS), BeiDou, Galileo, and wireless fidelity (Wi-Fi) based positioning) is nonexistent or unreliable or, where spatial resolution of existent location information is too large. As an example, method 201 can allow a mobile device to predict the food-related application when the mobile device is positioned in a kitchen of a user's home without knowing that the mobile device is positioned in the kitchen of the user's home, and can allow the mobile device to predict another application, such as a news-related application, when the mobile device is positioned in the user's bedroom without knowing that the mobile device is positioned in the bedroom of the user's home.

In another example, method 201 can allow a mobile device to send a message or a reminder to a user when the mobile device detects that it is positioned in a specific location. For instance, method 201 may allow the mobile device to send a correct meeting location when the mobile device is positioned in a wrong conference room. In another instance, method 200 may allow the mobile device to send a reminder to call a client when the mobile device enters the user's office, e.g., when the user accessed the mobile device. As such, performing method 201 enables the mobile device to be more user friendly and have a deeper connection with the user.

### III. Events Triggering Prediction

Prediction triggering events may be a predetermined set of events that trigger the identification of one or more applications to provide to a user. The events may be detected using signals generated by device components. Examples of prediction triggering events are discussed above. The description below may also apply to other triggering events.

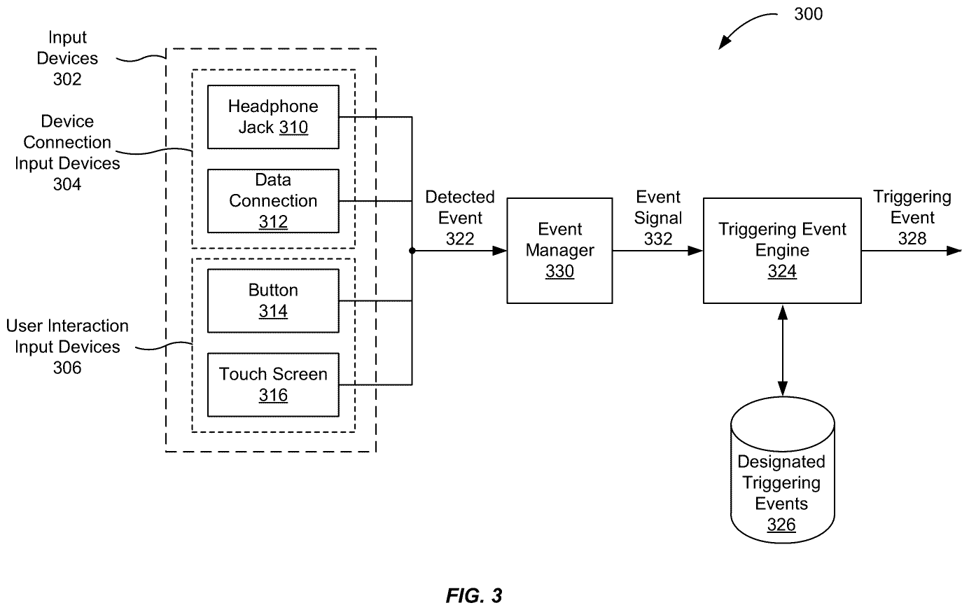

FIG. 3 illustrates a simplified block diagram of a detection system 300 for determining a triggering event. Detection system 300 may reside within the device for which a triggering event (also just called an “event”) is being determined. As shown, detection system 300 can detect a plurality of different events. One or more of the detected events may be determined by detection system 300 to be triggering events. Other processing modules can then perform processing using the triggering event.

### A. Detecting Events

The detection system 300 includes hardware and software components for detecting events. As an example, detection system 300 may include a plurality of input devices 302, such as input devices 302. In various embodiments, the input devices 302 can include a motion sensor. The motion sensors can detect motion for the mobile device. For example, the motion sensors can detect the mobile device moving and then stopping. The motion sensors can detect the mobile device being station for a period of time. The motion sensors can detect various orientations of the mobile device which can be used to detect an event. In various embodiments, the motion can be use as part of a trigger (e.g., motion detected in combination with a touchscreen or button input) as part of a combination event. Input devices 302 may be any suitable device capable of generating a signal in response to an event. For instance, input devices 302 may include device connection input devices 304 and user interaction input devices 306 that can detect device connection events (e.g., headphone jack, Bluetooth device, Wi-Fi connection, and the like) and user interaction events (e.g., buttons, switches, latches, touch screens, and the like), respectively. When an event is detected at an input device, the input device can send a signal indicating a particular event for further analysis.

### 1. User Interaction Events

User interaction input devices 306 may be utilized to detect user interaction events. User interaction events can occur when a user interacts with the device. Any suitable device component of a user interface can be used as a user interaction input device 306. A “user interface” can correspond to any interface for a user to generally interact with a mobile device or to interact with a specific application. Examples of suitable user interaction input devices are a button 314 and a touch screen 316. Button 314 of a mobile device may be a home button, a power button, volume button, and the like. In some cases, any input device that turns on a backlight of the mobile device may be a user interaction input device 306. A user interaction event can include the user moving the mobile device or changing its orientation (e.g., turning over the mobile device). When the user interacts with the device, it may be determined that a user has provided user input, and a corresponding user interaction event may be generated.

Touch screen 316 may allow a user to provide user input via a display screen. For instance, the user may swipe his or her finger across the display to generate a user input signal. When the user performs the action, a corresponding user interaction event is detected.

User interaction events can also include user actions within an application. For example, in a home application, a user's selection of an accessory device (e.g., turning on a room light, opening a garage door, and the like) can be a user interaction event. The user can select the accessory device via a touch screen or via voice commands.

### 2. Device Connection Events

Device connection events may be events that occur when other devices are connected to the device. For example, device connection input devices 304 can detect events where devices are communicatively coupled to the device. Any suitable device component that forms a wired or wireless connection to an external device can be used as a device connection input device 304. Examples of device connection input device 304 include a headphone jack 310 and a data connection 312, such as a wireless connection circuit (e.g., Bluetooth, Wi-Fi, Bluetooth Low Energy or BLE, and the like) or a wired connection circuit (e.g., Ethernet and the like).

The headphone jack 310 allows a set of headphones to couple to a device. A signal can be generated when headphones are coupled, e.g., by creating an electrical connection upon insertion into headphone jack 310. In more complex cases, headphone jack 310 can include circuitry that provides an identification signal that identifies a type of headphone jack to the device. The event can thus be detected in various ways, and a signal can be generated and/or communicated in various ways.

Data connection 312 may communicatively couple with an external device, e.g., through a wireless connection. For instance, a Bluetooth connection may be coupled to a computer of a vehicle, or a computer of a wireless headset. Accordingly, when the external device is coupled to the mobile device via data connection 312, it may be determined that an external device is connected, and a corresponding device connection event signal may be generated. As another example, when a beacon communication via BLE is received, it may be determined that an external device is connected. When an accessory device (e.g., a smart lock, a room light) is controlled via a wireless connection, it may also be determined that an external device is connected.

### B. Determine Triggering Events

As further illustrated in FIG. 3, input devices 302 can output a detected event 322, e.g., as a result of any of the corresponding events. Detected event 322 may include information about which input device is sending the signal for detected event 322, a subtype for a specific event (e.g., which type of button is pressed). Such information may be used to determine whether detected event 322 is a triggering event and may be passed to later modules for determining which predictor module to use to determine which application to suggest, what message should be sent, or which action to perform.

Detected event 322 may be received by an event manager 330. Event manager 330 can receive signals from input devices 302 and determine what type of event is detected. Depending on the type of event, event manager 330 may output signals (e.g., event signal 332) to different engines. The different engines may have a subscription with the event manager 330 to receive specific event signals 332 that are important for their functions. For instance, triggering event engine 324 may be subscribed to receive event signals 332 generated in response to detected events 322 from input devices 302. Event signals 332 may correspond to the type of event determined from the detected events 322.

Triggering event engine 324 may be configured to determine whether the detected event 322 is a triggering event, and potentially the type of triggering event. To make this determination, triggering event engine 324 may reference a designated triggering events database 326, which may be coupled to the triggering event engine 324. The designated triggering events database 326 may include a list of predetermined events that are designated as triggering events, and potentially what type of triggering event each is.

Triggering event engine 324 may compare the received detected event 322 with the list of predetermined events and output a triggering event 328 if the detected event 322 matches a predetermined event listed in the designated triggering events database 326. In various embodiments, the triggering event can be when the mobile device is stationary for longer than a specified period-of-time as determined by one or more motion sensors (e.g., an IMU). An example of the list of predetermined events may include pressing the power button, pressing the home button, or performing any other action that turns on a backlight of the mobile device, indicating that a user wishes to interact with the mobile device to perform an action or run an application.

### C. Identify Application(s) and Perform Associated Action(s)

Once a triggering event is detected, an application may be identified based on the triggering event. In some cases, identification of the application is not a pre-programmed action. Rather, identification of the application can be a dynamic action that may change depending on additional information. For instance, identification of the suggested application can be determined based on contextual information.

“Contextual information” refers collectively to any data that can be used to define the context of a mobile device. The contextual information for a given context can include one or more contextual data, each corresponding to a different property of the mobile device. The potential properties can belong to different categories, such as a time category (e.g., time information) or a location category. Contextual data can be used as a feature of a model (or sub-model), and the data used to train the model can include different properties of the same category. A particular context can correspond to a particular combination of properties of the mobile device, or just one property.

### IV. Use of Location for Predictions

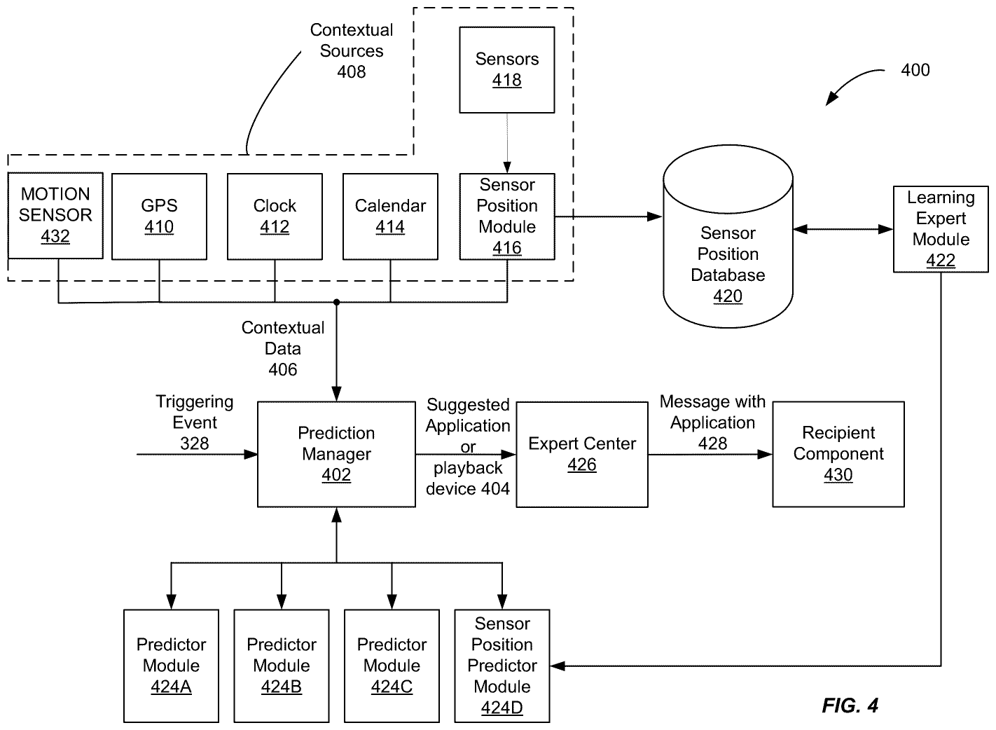

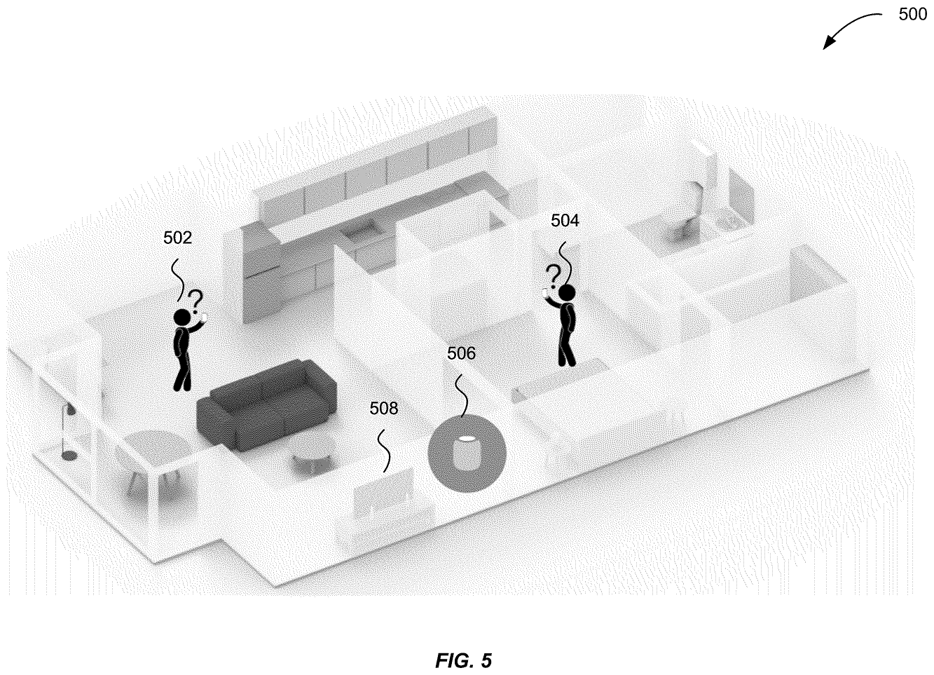

FIG. 4 illustrates a simplified block diagram of a prediction system 400 for identifying an application and a corresponding action based upon a triggering event and contextual information. Prediction system 400 resides within the mobile device that is identifying the application. Prediction system 400 may include hardware and software components.

Prediction system 400 includes a prediction manager 402 for identifying the suggested application, a playback device, or entry/departure from an AR area. Prediction manager 402 can receive a triggering event, such as the triggering event 328 discussed in FIG. 3. The prediction manager 402 may use information gathered from the triggering event 328 to identify a suggested application or playback device 404. As shown, the prediction manager 402 may receive contextual data 406 in addition to the triggering event 328.

The playback/streaming of media content from one electronic device to a remote device can be cumbersome. The user interface may take numerous clicks to navigate to identify and select a desired playback device. It would be desirable for an electronic device to determine a preferred remote/playback devices based on the user's location and known user behavior. These preferences are not just be limited to activity for certain Apps, but also consider the user behaviors at certain locations while at home or away or within the home at certain times of day or days of the week.

### A. Contextual Information

Contextual information may be gathered from contextual data 406 and may be received at any time. For instance, contextual information may be received before and/or after the triggering event 328 is detected. Additionally, contextual information may be received during detection of the triggering event 328. Contextual information may specify one or more properties of the mobile device for a certain context. The context may be the surrounding environment (type of context) of the mobile device when the triggering event 328 is detected. For instance, contextual information may be the time of day the triggering event 328 is detected. In another example, contextual information may be a certain location of the mobile device when the triggering event 328 is detected. In yet another example, contextual information may be a certain day of year at the time the triggering event 328 is detected. Additionally, contextual information may be data gathered from a calendar. For instance, the amount of time (e.g., days or hours) between the current time and an event time.

The contextual information may include information about current media content that is being played on the mobile device. For example, the contextual information may include information indicating whether the mobile device is currently streaming a media file to a playback device. The contextual information could indicate the type of media file being played (e.g., an audio file, a video file, etc.). The contextual information can also include information about devices associated with the mobile device. For example, the mobile device may be associated with a user account, or group of user accounts (e.g., a family plan), and the contextual information may include information about other mobile devices, or playback devices, that are associated with the account. Such contextual information may provide more meaningful information about the context of the mobile device such that the predicted app manager 402 may accurately suggest an application that is likely to be used by the user in that context. Accordingly, predicted app manager 402 utilizing contextual information may more accurately suggest an application to a user than if no contextual information were utilized.

Contextual data 406 may be generated by contextual sources 408. Contextual sources 408 may be components of a mobile device that provide data relating to the current context of the mobile device. For instance, contextual sources 408 may be hardware devices and/or software code that operate as an internal digital clock 410, GPS device 412, calendar 414, motion sensor 432, and a sensor position module 416 for providing information related to time of day, location of the mobile device, and day of year, motion (or acceleration) of the mobile device, and a sensor position of the mobile device, respectively. The sensors 428 can include optical sensors configured for use for AR applications. Other contextual sources may be used.

Sensor position module 416 may be software code configured to receive information from sensors 418 and write data to a sensor position database 420. The sensor position module 416 may receive measurements of sensor values from sensors 418 and store the measured values as a sensor position in an entry in sensor position database 420. Sensors 418 may be a hardware component that is configured to detect transmission signals, such as Wi-Fi signals, Bluetooth signals, radio frequency (RF) signals, and any other type of signal capable of transmitting information wirelessly. Sensor position module 416 may be coupled to a sensor position database 420 to store the detected sensor values for future reference by a learning expert module 422, as will be discussed further herein. Sensor position module 416 may then use the measured sensor values to output a sensor position to predicted app manager 402 as contextual data.

### B. Predictor Modules for Determining Recommendation

Predicted app manager 402 may then use information gathered from both the triggering event 328 and contextual data 406 to identify a suggested application 404. Predicted app manager 402 may also determine an action to be performed, e.g., how, and when a message including or using suggested application 404 is provided, as may occur by a user interface be provided for a user to interact with suggested application 404.

Predicted app manager 402 may be coupled to several predictor modules 424A-424D to identify the suggested application 404. Each predictor module 424A-424D may be configured to receive information from predicted app manager 402 and output a prediction back to predicted app manager 402. The information sent to predictor modules 424A-424D may include triggering event 328 and any relevant contextual data 406, and the prediction output to predicted app manager 402 may include one or more applications and their corresponding confidence value representing how likely the user will run the application based upon the received information.

Predictor modules 424A-424D may be configured for different purposes. For instance, predictor modules 424A-242D may be configured to predict an application based on a triggering event, predict an action for controlling an accessory of a home, predict an application that is not currently installed on a mobile device that a user may be interested in, and predict an application based upon a sensor position (i.e., sensor position predictor module 424D). Predictor modules 424A-424D may be used to recommend a playback device of a plurality of playback devices at a location.

Predictor modules 424A-424D may be used to detect when the mobile device is on a trajectory, is inside, or is on a trajectory to leave an AR area. For example, an AR map can define a plurality of AR areas in which one or more sensors (e.g., optical sensors) can be used for determining position of a user inside an AR area. The predictor modules 424A-424D can use the mobile device location along with a predicted motion of the mobile device to determine a trajectory of the mobile device with respect the defined AR areas.

The location can be determined using GNSS sensors (e.g., GPS), microlocation from the various cluster techniques, and/or motion sensors. Depending on which types of triggering events are detected, predicted app manager 402 may send the information to only those predictor modules. Thus, predicted app manager 402 may send information to one predictor module, a subset of predictor modules 424A-424D, or all predictor modules 424A-424D.

Each predictor module may have a set of one or more evaluation rules for determining a prediction (e.g., application(s) and action(s)) to send to predicted app manager 402. The set of evaluation rules for sensor position predictor module 424D can comprise a list of one or more applications that correspond to a sensor position or a cluster of sensor positions, along with one or more criteria and actions to be taken for the one or more applications. An evaluation rule can select one or more applications based on the one or more criteria. For example, a likelihood (e.g., a confidence value) of each of the applications can be provided, and a criterion can be to provide the top 5 most likely applications on a screen of a user interface, where such display can comprise a message. The set of evaluation rules can further include the confidence values of the application(s) in the list. The one or more criteria can include a predetermined set of contextual information that, when measured upon detection of a triggering event, indicate which of the applications in the list that are likely to be accessed by a user

Each set of evaluation rules may be a set of strings stored in memory or code compiled as part of an operating system. When predictor modules 424A-424D receive information from predicted app manager 402, predictor modules 424A-424D may compare the received information to the evaluation rules and output the predicted application and confidence that best fit the received information. As an example, sensor position predictor module 424D may have a set of evaluation rules establishing that if the sensor position is within cluster 1, then the likelihood of the user running the food-related application is at a confidence value of 90%; and if the sensor position is within cluster 2, then the likelihood of the user running the news-related application is at a confidence value of 80%.

Although the example discusses considering the sensor position of the mobile device, other contextual data 406 may also be considered to determine a predicted application and its corresponding confidence value. For instance, time of day and day of the week may also influence the prediction determined by predictor modules 424A-424D.

Once predicted app manager 402 receives the predicted application from predictor modules 424A-424D, the predicted app manager 402 may send the suggested application 404 to an expert center 426. The expert center 426 may be a section of code that manages what is displayed on a mobile device, e.g., on a lock screen, when a search screen is opened, or other screens. For instance, the expert center 426 may coordinate which information is displayed to a user, e.g., a suggested application, suggested contact, and/or other information. Expert center 426 can also determine how to provide such information to a user. As aforementioned herein, a particular user interface provided to the user may depend on a degree of probability of being performed by the user. The higher the probability of use, more aggressive action can be taken, such as automatically opening an application with a corresponding user interface (e.g., visual or voice command), as opposed to just providing an easier mechanism to open the application.

If the expert center 426 determines that it is an opportune time for the suggested application (or a message generated by the suggested application) to be output to the user, e.g., when the user has not yet run an application on the mobile device but is actively interacting with the mobile device, the expert center 426 may output a message 428 with suggested application 404 to a recipient component 430. Recipient component 430 may be a user interface of the mobile device itself, or a user interface of another device, such as a tablet, laptop, smart watch, smartphone, or other mobile device. As another example, recipient component 430 may be another application on the mobile device or an application of another device, where the application may be an operating system (e.g., in firmware) of the other device, as may occur when a command message is sent to another device to perform an action. In various embodiments, the recipient component 430 can be a playback device. The prediction manager 402 can use the available information to recommend a playback device for a user seeking to stream a media file. In cases where suggested application 404 is included in message 428, recipient component 430 (e.g., a user interface) may communicate the suggested application 404 to the user and solicit a response from the user regarding the suggested application 404.

Recipient component 430 may require different levels of interaction for a user to run the suggested application 404. The various levels may correspond to a degree of probability that the user will run suggested application 404. For instance, if the predicted app manager 402 determines that suggested application 404 has a probability of being run by the user that is greater than a threshold probability, recipient component 430 may output a prompt that allows the user to more quickly run the application by skipping one or more intermediate steps.

Alternatively, if predicted app manager 402 determines that the probability of the user running the identified application is less than the high threshold probability, but still higher than a lower threshold probability, the identified application may be displayed as an icon. The lower threshold probability may be higher than a baseline threshold probability. The baseline threshold probability may establish the minimum probability at which a corresponding application will be suggested. The user may thus have to perform an extra step of clicking on the icon to run the identified application. However, the number of clicks may still be less than the number of clicks required when no application is suggested to the user. The threshold probability may vary according to application type. In some cases, the high threshold probability may range between 75% to 100%, the lower threshold probability may range between 50% to 75%, and the baseline threshold may range between 25% to 50%. In an example, the high threshold probability is 75%, the lower threshold probability is 50%, and the baseline probability is 25%.

In some cases, higher probabilities may result in more aggressive application suggestions. For instance, if an application has a high probability of around 90%, predicted app manager 402 may provide an icon on a lock screen of the mobile device to allow the user to access the application with one click of the icon. If an application has an even higher probability of around 95%, predicted app manager 402 may even automatically run the suggested application for the user without having the user click anything. In such instances, predicted app manager 402 may not only output the suggested application, but also output a command specific to that application, such as a command to open the first article in the news-related application or a command to query the user to accept or decline initiating a set of predetermined actions.

In some cases, predicted app manager 402 may determine what level of interaction is required, and then output that information to expert center 426. Expert center 426 may then send this information to recipient component 430 to output to the user.

In some cases, recipient component 430 may display a notice to the user on a display screen. The notice may be sent by a system notification, for instance. The notice may be a visual notice that includes pictures and/or text notifying the user of the suggested application. The notice may suggest an application to the user for the user to select and run at his or her leisure. In some cases, for more aggressive predictions, the notification may also include a suggested action within the suggested application. That is, a notification may inform the user of the suggested application as well as a suggested action within the suggested application. The user may thus be given the option to run the suggested application or perform the suggested action within the suggested application. As an example, a notification may inform the user that the suggested application is the news-related application, and the suggested action is to access the first article within the news-related application. The user may indicate that he or she would like to read the first article by clicking on an icon indicating the first article. Alternatively, the user may indicate that he or she would rather run the application to read another article by swiping the notification across the screen.

In some cases, the mobile device may identify what application is run at a sensor position, and then draw an association between the sensor position and the application. The application may be stored in sensor position database 420 along with the corresponding sensor position. In some cases, sensor position database 420 may store sensor position data during a certain period of time. As an example, sensor position database 420 may store sensor position data measured during the last seven weeks. Knowing which application is run at the sensor position helps evaluate the user's habits to update the evaluation rules stored in sensor position predictor module 424D for use in predicting applications in line with the user's habits. In some cases, an expert module can routinely update predictor modules 424A-424D.

### C. Using Historical Information to Inform Prediction Module

As shown in FIG. 4, a learning expert module 422 is coupled to sensor position database 420 and sensor position predictor module 424D. Learning expert module 422 may be configured to update a set of evaluation rules contained in sensor position predictor module 424D. Although FIG. 4 only shows one learning expert for updating one predictor module, techniques are not so limited. For instance, learning expert module 422 can also be configured to update any of predictor modules 424A-424C. In other instances, additional learning experts may be implemented in prediction system 400 for updating predictor modules 424A-424C.

Learning expert module 422 may be a software module configured to access sensor position database 420 and analyze its stored information to generate an updated set of evaluation rules for sensor position predictor module 424D. Learning expert module 422 may include one or more prediction models (not shown). Each prediction model may be a section of code and/or data that is specifically designed to identify an application for a specific triggering event. For instance, one prediction model may be specifically designed to identify an application for a triggering event associated with a turning on of a backlight of the mobile device. Each prediction model may be coupled to the contextual sources so that each prediction model may utilize contextual information to identify a suggested application. Examples of prediction models include neural networks, decision trees, multi-label logistic regression, and combinations thereof, and other types of supervised learning. Further details can be found in U.S. patent application Ser. Nos. 14/732,359 and 14/732,287, which are incorporated by reference in their entirety.

As mentioned herein, sensor position database 420 may store sensor position data for a specific period of time, e.g., the past seven weeks of use. Thus, the updated set of evaluation rules generated by learning expert module 422 for sensor position predictor module 424D may reflect the pattern of device usage across the past seven weeks. In some cases, once learning expert module 422 has generated an updated set of evaluation rules, learning expert module 422 may be deleted and removed from memory. Next time the sensor position predictor module 424D is updated, learning expert module 422 may be initiated again to generate an updated set of evaluation rules and then deleted once again. Deleting learning expert module 422 after generating an updated set of evaluation rules saves memory space and increases device performance.

In some cases, learning expert module 422 may be periodically run. The time at which learning expert module 422 is run may depend on the availability of the mobile device and the likelihood of being used by the user. As an example, learning expert module 422 may be run every night when the user is asleep, e.g., after sensor position module determines clusters of sensor positions. In such instances, the mobile device is typically connected to a power source to charge its battery and the user is not likely to access the mobile device and interrupt the operations of learning expert module 422.

### D. Example Use Cases

Location can be used to predict applications and actions for a mobile device. The predictions can be based on the mobile device's past actions and associations between the mobile device, playback devices, and other mobile devices. For example, a mobile device may present a graphical user interface for a music program (e.g., an application) and the interface can suggest that the user stream an audio file to a particular playback device (e.g., an action). The action and application can be suggested because the mobile device has a previously streamed audio files to that playback device at the device's current location.

The mobile device can use a mobile device's current location to suggest applications to a user. The device may be at a location where the user has previously streamed media content to playback devices, and the mobile device may suggest (e.g., present as graphical element on a user interface) applications that permit streaming to playback devices. The suggested applications can be based on the past behavior (e.g., an activity log) of the mobile device. For example, the list of suggested applications may only include that the mobile device has previously used to stream content to playback devices at the current location or at any location.

The suggested actions for a particular application can be based on historical information about the mobile device's actions with the application. For example, a suggested action may include a prompt to stream media content from the mobile device to a remote playback device. Some applications may be capable of streaming different types of media content. For example, an application may include audio media content and video media content. The historical information can indicate that the mobile device is more likely to stream audio content in the current location, from the application, or from the application at the current location. The mobile device, after identifying the application, can present a graphical user interface with suggested actions for the application. The user interface can include a graphical element suggesting that the user stream an audio file to eligible playback devices because the historical information indicates that the mobile device is more likely to stream audio files from the application. Similarly, the user interface can include a graphical element suggesting that the user stream a video file to eligible playback devices because the historical information indicates that the mobile device is more likely to stream video files from the application.

The suggested actions and applications can be based on the historical information about interactions between devices. The suggested actions may include identifying playback devices. These playback devices can be suggested because of an association between a user account of the mobile device and a user account of the playback device (e.g., the two user accounts are the same or associated). An associated playback device may be suggested if the historical information indicates that the mobile device has performed the currently suggested action with that device in the past. In some embodiments, an associated playback device may not be suggested if the historical information indicates that the mobile device does not have a history of interacting with the playback device.

The mobile device's current action may be used to suggest additional actions or applications. For example, a mobile device may be streaming media content to a playback device. The mobile device may present a graphical user interface that identifies other eligible playback devices that are in range of the mobile device. The eligible playback devices can be devices that are in the mobile device's current location and are capable of playing the currently streamed media content. The mobile device's movement may be used to suggest the playback devices, and, for example, a mobile device that is streaming media content to a playback device associated with a first location may be presented with eligible playback devices in a second location when the mobile device moves to that second location.

Actions or applications may be suggested for a mobile device based on the current actions of other mobile devices. For example, two or more mobile devices may be associated with a user account. One of the other mobile devices may be streaming media content to a playback device, and this action may cause the mobile device to present a graphical user interface for controlling the playback device. The graphical user interface may be presented if both of the associated devices are in the same location. The graphical user interface, and any other graphical user interface in this disclosure, may be presented on a lock screen for the mobile device.

The suggested applications or actions may be presented in an interface graphic (e.g., a widget). The interface graphic can present information from an application executing on the mobile device and receive input to the application. The interface graphic can have limited functionality when compared to the application associated with the interface graphic, but the interface graphic may have higher priority access to the mobile device's processors. For example, the interface graphic may be able to wake the processor from a low power mode and the application may only be able to interact with the processor when it is awake.

The interface graphic may present suggested actions and applications within the graphic. For example, the interface graphic may present a suggested media file for streaming. The suggested actions may be based on context for the mobile device. The mobile device may detect that the device's movement is above a threshold (e.g., from motion sensor output). In response, the mobile device may determine the device's current location. The location can be updated if subsequent movement of the mobile device is detected. Using this location, the mobile device can suggest a playback device in the location in response to an input to the interface graphic (e.g., pressing a play button).

The suggested actions may include disconnecting the mobile device from playback devices. For example, mobile device may receive input to an application, and, in response, the mobile device may be connected to a playback device for streaming media content from the application. The mobile device may not stream media content to the playback device, or the device may pause streaming. After a threshold amount of time has passed, the mobile device may disconnect the playback device so that the mobile device does not inadvertently stream media content to an unintended playback device. The threshold amount of time can be 1 second, 5 seconds, 10 seconds, 15 seconds, 30 seconds, 45 seconds, 1 minute, 5 minutes, 8 minutes, or 10 minutes.

### V. Efficient Triggering of New Ranging Sessions

Mobile devices can use several different sensors for accurate navigation. These sensors can be used to determine a position of the mobile device even when indoors or when GNSS information is unavailable. However, some of these different location techniques can incur a processing time penalty when calculating the position of the mobile device from the sensor information. This processing time can result in undesirable delays in loading applications and can result in a poor user experience when using these mobile device applications. Further, it is desirable for the mobile device to proactively maintain a balance between navigation sensor use and battery energy conservation. Other types of sensors (e.g., motion sensors) can be used to determine the location of the mobile device has changed sufficiently to warrant using activating sensors.

### A. Use of Motion Sensor and Sensor Location

Motion sensors (e.g., accelerometers or an IMU) can be incorporated into mobile device. These sensors can be run in the background and use minimal power. The motion sensor can detect acceleration over a period-of-time. The acceleration and time information can be used to determine a distance moved. A mobile device can experience a plurality of accelerations over discrete periods of time. This motion can be determined for a plurality of discrete time periods to determine a several distances that can be combined to determine a device's movement from a start location. For example, if a user is pacing back and forth, the mobile device can experience motion in a first direction for a first period-of-time and motion in a second direction over a second period of time. The mobile device can determine distances for the first period of time and the second period of time. The distances can be combined to determine if the mobile device has moved more than a preset amount (e.g., 3 meters).

The mobile device can combine the various distances calculated to determine the movement of the mobile device. For example, if the mobile device has moved more than a certain amount, this may trigger activation of a ranging session to update a location of the mobile device. The updated location can be used to determine a relevant playback device for streaming a media file. In various embodiments, the updated location can be used to determine if the mobile device is on a trajectory, inside, or outside of an AR bubble to automatically activate or deactivate various sensors (e.g., optical sensors).

FIG. 5 illustrates an exemplary environment 500 for determining an updated location of a mobile device. FIG. 5 illustrates an indoor environment in which GNSS signals may be unavailable. Further, GNSS signals, if available, may not be precise enough to determine a location of the mobile device within the room. A user with a mobile device at first location 502 may want to stream some media content to a playback device (e.g., a smart speaker 506 or a smart television 508). If just GNSS information is used the mobile device may not be able to differentiate between the first location 502 in the room and a second location 504 in a different room.

The mobile device may periodically use ranging techniques to update the precise location of the mobile device. However, if the mobile device is stationary (e.g., the user is on couch) the position of the mobile device may not change and the ranging techniques may unnecessarily drain the power of the mobile device. To avoid unnecessary ranging sessions the mobile device can use motion sensors to determine an efficient time for updating the position of the mobile device.

The updated location of the mobile device may be used for many different applications. For example, the updated location can be used to determine a relevant playback device for streaming media content. In various embodiments, an App being executed on the mobile device for the first user at the first location 502 may recommend one of more playback devices based on a location of the first user and previous behavior of the first user. The updated location can be used to determine when the mobile device is on a trajectory to enter or exit an AR area for sensor activation or deactivation.

If the location of the mobile device is not updated, an App may provide a poor user experience. For example, if the user moves from a first location 502 in a first room to a second location 504 in the second room, the playback devices (e.g., a smart speaker 506 or a smart television 508) that are in the first room may not be relevant to the user. The second location 504 can be a few seconds, a few minutes, days, weeks, or months apart from the time the first location 502.

The second location 504 can be determined using the ranging techniques described above. Various techniques to determine the second location 504 can include an RF scan (e.g., Wi-Fi, BLE, UWB). However, this RF scan can take result in some lag while the second location 504 is determined and can increase the power consumption of the mobile device to conduct the RF scan.

Techniques using motion sensors can determine motion between two moments relatively close in time (e.g., seconds, maybe minutes). If the motion results in the mobile device moving a distance greater than a threshold amount, an updated location can be calculated.

### B. Using Motion as a Trigger for Ranging

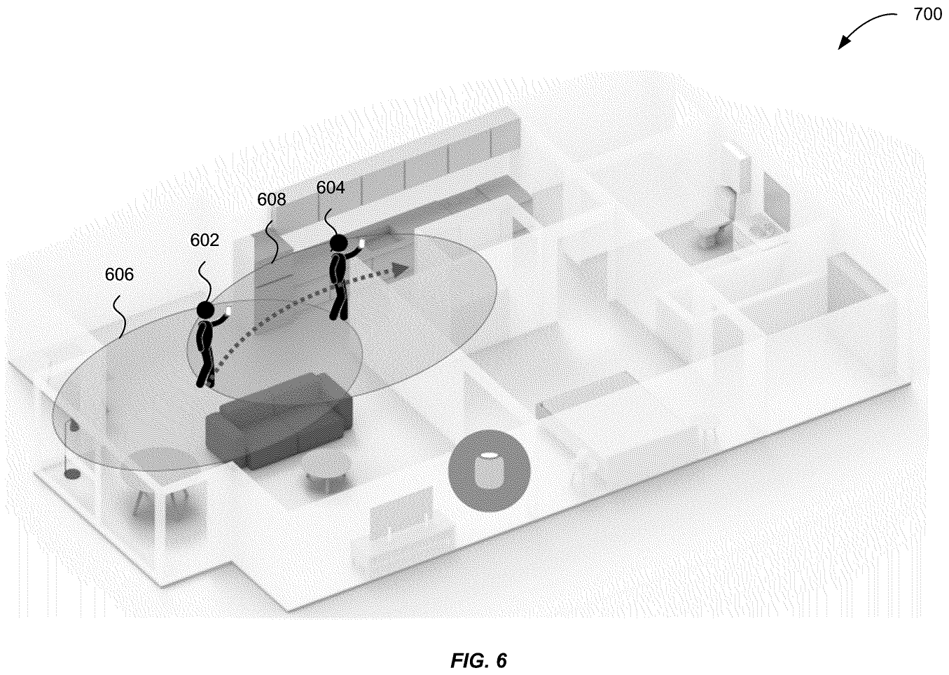

FIG. 6 illustrates a second exemplary environment 600 for efficient location techniques. The mobile device of the user at a first location 602 can determine a first geofence 606. The first geo-fence can be a defined area around the mobile device. For example, the first geo-fence can be a circular area having a radius of three meters. The mobile device can use varying size geo-fences to determine whether or not the mobile device has stopped moving. The radius of the geo-fence can be predefined and may change as needed. For example, if the geo-fence is being used to determine if the mobile device has stopped moving, the geo-fence may initially be a first value (e.g., three meters.) If the geo-fence has not been crossed in a time period, the size of the geo-fence may be adjusted (e.g., two meters, one meter or one-half meter) to determine if the mobile device crosses the shorter range geo-fence. For example, if a geo-fence has not been breached for a predetermined period-of time, a subsequent smaller geo-fence can be used to determine if the mobile device is still moving. Several consecutive smaller geo-fences can be used to detect whether or not the mobile device is stationary. The updated location determination (e.g., a RF scan) can be performed once the device is not moving past some threshold distance.

One or more sensors (e.g., an inertial measurement unit) can detect motion of the mobile device. An inertial measurement unit (IMU) is an electronic device that measures and reports a device's specific force, angular rate, and sometimes the orientation of the body, using a combination of accelerometers, gyroscopes, and sometimes magnetometers. The sensors can determine a velocity of the mobile device. A distance of travel for the mobile device can be determined by determining the velocity and the elapsed time at that velocity.

In various embodiments, the mobile device can establish a geo-fence a predetermined distance (e.g., three meters) from a present location of the mobile device. The predetermined distance can vary, and multiple geo-fences of different sizes can be used. The mobile device can use the sensors to detect when the geo-fence has been breached. For example, if the mobile device moves greater than the predetermined distance the mobile device can exit the first geo-fence 606. As the mobile device leaves the first geo-fence, a second geofence 608 can be established at a second location 604. The motion sensors can then determine whether or not the second geo-fence 608 has been breached.

The mobile device can use the geo-fences to determine whether or not an updated location (e.g., a RF scan) is needed to update the current location of the mobile device. In various embodiments, the mobile device can wait until the mobile device is stationary for a predetermined period-of-time prior to updating the location.

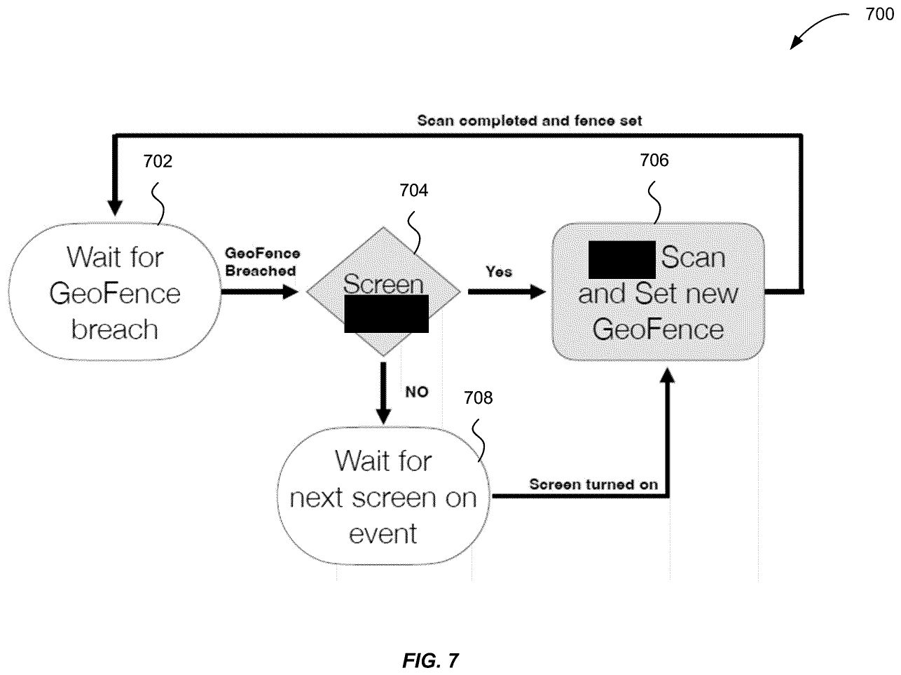

FIG. 7 illustrates a flow chart for a process 700 for determining when to update a location of a mobile device (e.g., updating an RF scan). It may not be efficient for the mobile device to update its portion while it is in motion. For example, if the mobile device is moving from a first room to a second room, the mobile device may cross several geo-fences. However, if the user is not using applications on the mobile device while traveling, the mobile device may wait until stationary to update the position. The mobile device may also use the orientation (e.g., screen face up so it can be used by a user) to determine an optimum time to update the location of the mobile device.

At block 702, the mobile device can determine if the geo-fence has been breached as described above. The mobile device can use one or more sensors to determine if the geo-fence has been breached. The one or more motion sensors can include an IMU. If the motion sensors detect that the mobile device has moved more than a predetermined distance. Even if the mobile device has moved more than the predetermined distance (e.g., breaching the geo-fence), conditions may exist that cause the mobile device to delay conducting the RF scan. For example, the mobile device may wait until the display is active prior to conducting the RF scan. For example, the device can be packed in a pocket or in a bag and the motion sensors may detect that the geo-fence has been breached. However, the user may not be actively using the mobile device, therefore the screen is not active, and it would be a waste of power for the mobile device to update the RF scan.

At block 704, the mobile device can determine if the screen is active. The screen is active if the mobile device is on, and the screen is unlocked and not in a screen saver or power saving mode. One or more display sensors can be used to determine if the screen is active.

At block 706, the screen is determined to be active, and the geo-fence is breached the mobile device can update the location (e.g., conducting an RF scan). The mobile device can set a new geo-fence after the scan is completed. The mobile device can then monitor for breach of the new geo-fence.

At block 708, the mobile device can wait for the next screen active event. After the screen is detected as being active, the mobile device can proceed to block 706.

### C. Example Use Cases (e.g., Predictive Routing)

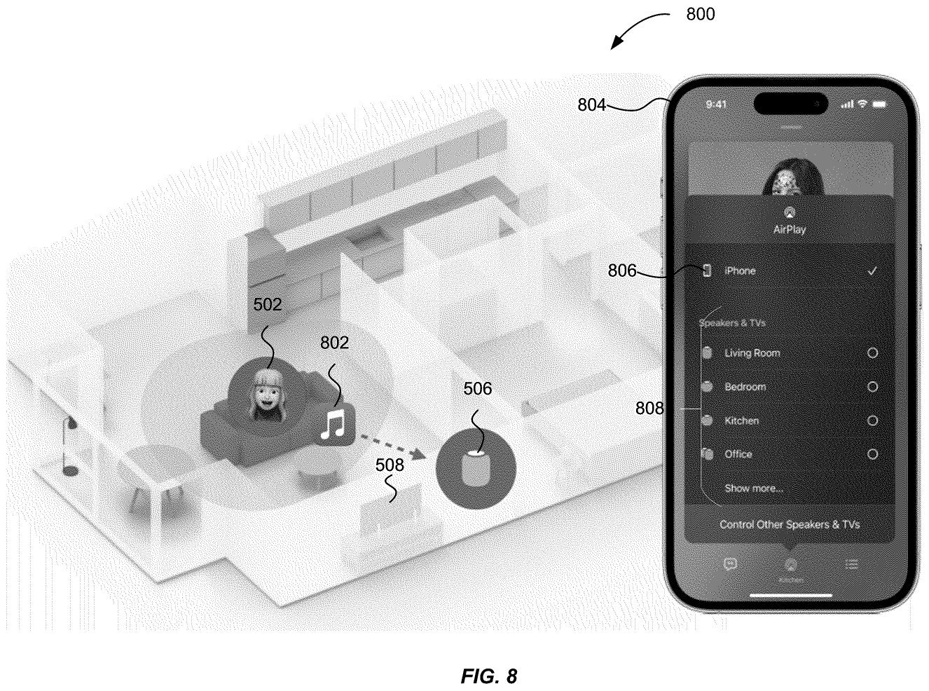

FIG. 8 illustrates a third exemplary environment 800 for determining an updated position of a mobile device. The first user at a first location 502 can select a media file 802 on the mobile device to stream to a playback device (e.g., a smart speaker 506 or a smart television 508). While only two playback devices are depicted, a location may include many different playback devices (e.g., multiple smart speakers, one or more tablet computers, one or more laptop computers, one or more desktop computers, or one or more wearable devices). The mobile device 804 can display the streaming device 806 and a list of potentially relevant playback devices 808 (e.g., living room device, bedroom device, kitchen device, office device). A user at the first location 502 can select one of these playback devices 808 by tapping on the name of the selected device on the screen of the mobile device 804.

In various embodiments, the mobile device can store user behavioral history per App and per location (e.g., a room or a position in the room). For example, if a first user is sitting on a couch in a living room often used a smart speaker 506 for playback of audio media from a music App, the smart speaker 506 can receive a higher priority in the list of recommended playback devices 808.

User experience expectations dictate a low latency requirement. This means that the recommendations are quickly listed for the user to select the desired playback device. The mobile device can detect patterns of behavioral history that uses the location of events that can be spread across a number of days.

In other embodiments, the updated position of the mobile device can be used to determine if the mobile device is on a trajectory to enter an AR area. The AR area can be a designated area of a plurality of areas in which sensors (e.g., inertial, optical, or inertial-optical) of a mobile device can be used to determine a precise location. If the mobile device is projected to enter or is within an AR area the mobile device can automatically activate one or more sensors. If the mobile device is projected to leave an AR area, the mobile device can actively de-activate the one or more sensors. Other use cases can be contemplated.

### VI. Flow for Efficient Locating of Mobile Device

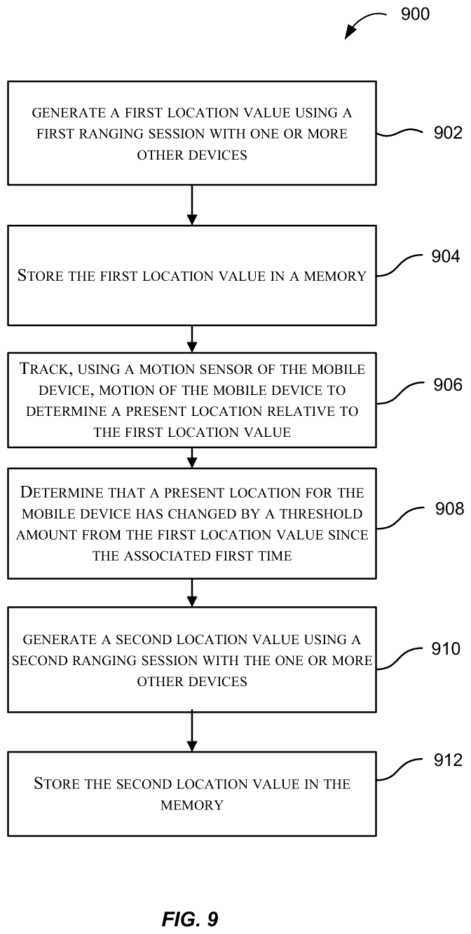

FIG. 9 illustrates a flow chart for a process 900 for determining when to update a location of a mobile device (e.g., updating an RF scan). The method can be performed by one or more processors of a mobile device. The method can also use a motion sensor (e.g., an IMU). In various embodiments, the mobile device can use one or more wireless sensors to update the location of the mobile device if the motions sensors detect that the mobile device has moved more than a threshold amount.

At block 902, responsive to a trigger signal at an associated first time, process 900 may include, generating a first location value using a first ranging session with one or more other devices. The ranging session can include sending and receiving wireless signals. The ranging session can use received wireless signals to triangulate a location or a cluster that the mobile device is located. The wireless signals (e.g., Wi-Fi, BT, BLE, UWB signals) can emitted from any signal source, e.g., electronic devices, such as a wireless router, a Wi-Fi equipped appliance (e.g., set top box, smart home device), or a Bluetooth device. In various embodiments, the first location value can be triangulated from receiving various wireless signals.

A triggering event can be identified as an event sufficiently likely to correlate to an operation of the mobile device. A triggering event can be caused by a user and/or an external device. For instance, the triggering event can be a specific interaction of the user with the mobile device. In various embodiments, the triggering event can be when the mobile device is stationary for longer than a specified period-of-time as determined by one or more motion sensors (e.g., an IMU). The specific interaction can be used to learn what the user does at a particular position, and thus can be considered a learning triggering event. Examples of learning triggering events are application launches, specific activity within an application (e.g., making a selection within the application), voice commands (e.g., to initiate at voice assistant to perform searching or other activity with an application), and a first interaction of the day. As other examples, a triggering event can be when an accessory device is connected to the mobile device, e.g., inserting headphones into a headphone jack, making a Bluetooth connection, and the like. A list of events that are triggering events can be stored on the mobile device. Such events can be a default list and be maintained as part of an operating system and may or may not be configurable by a user.

According to an example, one or more process blocks of FIG. 9 may be performed by a mobile device (e.g., a smartphone, a tablet device, a wearable device, and a laptop).

At block 904, process 900 may include storing the first location value in a memory of the electronic device. The first location value can be stored locally on the mobile device memory or can be stored in a cloud-based service.

At block 906, process 900 may include tracking, using a motion sensor of the mobile device, motion of the mobile device to determine a present location relative to the first location value. In various embodiments, the motion sensor can be an accelerometer of the mobile device. In various embodiments the sensor can be an IMU of the mobile device. The accelerometer can determine motion of the mobile device over a period of time. The motion and time can be used to determine a dead reckoning position of the mobile device. For example, if the motion of the mobile device is 1.5 meters per second, after 2 seconds the mobile device can have moved 3 meters from a previous position. A series of locations can be stored in the memory of the electronic device. The series of locations can be used to determine motion of the mobile device.

At block 908, process 900 may include determining that a present location for the mobile device has changed by a threshold amount from the first location value since the associated first time. The mobile device can establish one or more geo-fence. A geo-fence can be a predetermined radius around a certain location. The predetermined amount can vary. For example, the predetermined amount can be 0.5 meters, 1 meter, 2 meters, 4 meters, etc. The mobile device can use the detected motion over a period of time to determine if the mobile device has moved more than a threshold from the first location. For example, a user may be sitting on a couch but using the mobile device. However, the movement of the mobile device would not be greater than the predetermined threshold amount. Therefore, the mobile device would not update its position using ranging techniques. However, if the person stands and walks out of the room, the mobile device can detect that the predetermined threshold amount has been exceeded and trigger updating the position. In various embodiments, the motion sensor can include an accelerometer.

In various embodiments, in addition to the mobile device moving more than a threshold value since the associated first time, the mobile device may verify that other conditions are met. For example, in various embodiments, the second ranging session also requires that a screen of the mobile device is facing towards a user. In various embodiments, the second ranging session also requires that a screen of the mobile device is active.

At block 910, responsive to the present location for the mobile device having changed by more than the predetermined threshold amount since the associated first time, process 900 may include generating a second location value using a second ranging session with the one or more other devices. The second ranging session can include sending and receiving wireless signals. The second ranging session can use received wireless signals to triangulate a location or a cluster that the mobile device is located. The wireless signals (e.g., Wi-Fi, BT, BLE, UWB signals) can emitted from any signal source, e.g., electronic devices, such as a wireless router, a Wi-Fi equipped appliance (e.g., set top box, smart home device), or a Bluetooth device. In various embodiments, the second location value can be triangulated from receiving various wireless signals.

In various embodiments, the mobile device delays generating the second location value until a screen of the mobile device is active. The screen of the mobile device is active if the mobile device is not displaying a screen saver or in a power-saving mode.

In various embodiments, the mobile device can detect if the display screen is facing down which can be an indication that the mobile device is not being used. If the display, is detected as being down, the subsequent ranging session can be delayed until the device is in an orientation that suggests it is being used.

In various embodiments, process 900 may include establishing a series of progressively smaller geo-fences to determine that the mobile device has stopped moving. For example, the first geo-fence can be 5 meters, the second 2 meters, the third 1 meter, etc.

In various embodiments, the mobile device delays generating the second location value until the mobile device is stationary for a predetermined period of time.

At block 912, process 900 may include storing the second location value in the memory. For example, device may store the second location value in the memory, as described above. The second location value can be stored locally on the mobile device memory or can be stored in a cloud-based service.

Process 900 may include additional implementations, such as any single implementation or any combination of implementations described below and/or in connection with one or more other processes described elsewhere herein. A first implementation, process 900 further includes determining a playback device for a streaming service based on the first location value or the second location value.

In various embodiments, process 900 further includes receiving a notification from a playback device instructing the mobile device to generate a third location value using a third ranging session for the mobile device. The third location value can be generated using one or more of the location techniques described above.

It should be noted that while FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

According to some embodiments, the one or more target objects can be provided to the user as recommendations. According to some other embodiments, an action can be automatically performed based on the one or more target objects.

According to some embodiments, the mobile device can periodically measure the sensor values. Once the likelihood of using an application, accessory device, or performing an action is sufficiently high, target objects can be predicted by performing the steps of 910 and 912.
Predicting the one or more target objects can include comparing, by an arbiter module, outputs of the respective prediction models to determine which one or more targets objects to provide on a user interface, to implement, or to provide to another software module on the mobile device. For example, an action act be performed or the recommendation (e.g., a device) can be provided to another software module that communicates with the device.

It should be appreciated that the specific steps illustrated in FIG. 9 provide a particular method of predicting target objects according to some embodiments. Other sequences of steps may also be performed according to alternative embodiments. For example, alternative embodiments of the present invention may perform the steps outlined above in a different order. Moreover, the individual steps illustrated in FIG. 9 may include multiple sub-steps that may be performed in various sequences as appropriate to the individual step. Furthermore, additional steps may be added or removed depending on the particular applications. One of ordinary skill in the art would recognize many variations, modifications, and alternatives.

In various aspects, a mobile device can include one or more processors and a memory storing a plurality of instructions that when executed by the one or more processors perform all or part of process 900 as described above.

In various aspects, a computer-readable medium can store a plurality of instructions that when executed by one or more processors can perform all or part of process 900 as described above.

### VII. Predictive Actions for Augmented Reality Bubbles Based on Location

Augmented reality systems can use one or more sensors (e.g., a camera) to localize the position of a mobile device within a virtual map. The one or more sensors can determine position of the mobile device based on the relative location of various objects in an area of interest. For example, a user with the mobile device can map their position from a room in the real world to a position in a virtual world based on relative location from various items, objects, and barriers in the real work which can be mapped into the virtual world. For example, a room such as a bedroom can include four walls, a bed, a nightstand, a closet, a door, and a lamp. The items for the bedroom can be mapped into a virtual space. Once the items for the bedroom are mapped into a virtual bedroom, the sensors on the mobile device can map the user into the virtual world based on a relative location from the various mapped objects.

Augmented Reality (AR) applications may experience lag upon activation due to the determination of the position of the mobile device with respect to augmented reality areas (also referred to as bubbles). There can also be lag in the loading of the AR app. The preloading techniques can help the process run faster. Traditional ranging services can be time consuming and can result in inefficient use of battery resources. The lag in determining a position of the device can result in poor user experience. Location techniques can be used to determine when the mobile device is approaching, leaving, or within certain defined locations.

### A. Example AR Devices

Optical tracking can use cameras placed on or around a device (e.g., a mobile device, such as a phone or a headset) to determine position and orientation based on computer vision algorithms. This method can be based on the same principle as stereoscopic human vision. When a person looks at an object using binocular vision, he/she is able to define approximately at what distance the object is placed due to the difference in perspective between the two eyes. In optical tracking, cameras can be calibrated to determine the distance to the object and its position in space. Optical systems are reliable and relatively inexpensive, but they can be difficult to calibrate. Furthermore, the system may require a direct line of light without occlusions, otherwise it will receive wrong data.

Optical tracking can be done either with or without markers. Tracking with markers can involve targets with known patterns to serve as reference points, and cameras constantly seek these markers and then use various algorithms (for example, POSIT algorithm) to extract the position of the object. Markers can be visible, such as printed Quick Reference (QR) codes, but many use infrared (IR) light that can only be picked up by cameras. Active implementations feature markers with built-in IR LED lights which can turn on and off to sync with the camera, making it easier to block out other IR lights in the tracking area. Passive implementations can include retroreflectors which reflect the IR light back towards the source with little scattering. Markerless tracking does not require any pre-placed targets, instead using the natural features of the surrounding environment to determine position and orientation.

In outside-in tracking, cameras can be placed in stationary locations in the environment to track the position of markers on the tracked device, such as a head mounted display or controllers. Having multiple cameras allows for different views of the same markers, and this overlap allows for accurate readings of the device position. For example, virtual reality (VR) systems (e.g., the original Oculus Rift) can utilize this technique, placing a constellation of IR LEDs on its headset and controllers to allow external cameras in the environment to read their positions. Outside-in tracking is the most mature, having applications not only in VR but also in motion capture technology for film. However, this solution is space-limited, needing external sensors in constant view of the device.

For inside-out tracking, the camera can be placed on the tracked device and look outward to determine its location in the environment. Headsets that use this tech have multiple cameras facing different directions to get views of its entire surroundings. This method can work with or without markers. The Lighthouse system used by the HTC Vive is an example of active markers. Each external Lighthouse module contains IR LEDs as well as a laser array that sweeps in horizontal and vertical directions, and sensors on the headset and controllers can detect these sweeps and use the timings to determine position. Markerless tracking, such as on the Oculus Quest, does not require anything mounted in the outside environment. It can use cameras on the headset for a process called SLAM, or simultaneous localization and mapping, where a 3D map of the environment is generated in real time. Machine learning algorithms then determine where the headset is positioned within that 3D map, using feature detection to reconstruct and analyze its surroundings. This tech allows high-end headsets like the Microsoft HoloLens to be self-contained, but it also opens the door for cheaper mobile headsets without the need of tethering to external computers or sensors.

Inertial tracking can use data from accelerometers and gyroscopes, and sometimes magnetometers. Accelerometers measure linear acceleration. Since the derivative of position with respect to time is velocity and the derivative of velocity is acceleration, the output of the accelerometer could be integrated to find the velocity and then integrated again to find the position relative to some initial point. Gyroscopes measure angular velocity. Angular velocity can be integrated as well to determine angular position relatively to the initial point. Magnetometers measure magnetic fields and magnetic dipole moments. The direction of Earth's magnetic field can be integrated to have an absolute orientation reference and to compensate for gyroscopic drifts. Modern inertial measurement unit's systems (IMU) are based on MEMS technology allows to track the orientation (roll, pitch, yaw) in space with high update rates and minimal latency. Gyroscopes are always used for rotational tracking, but different techniques are used for positional tracking based on factors like cost, case of setup, and tracking volume.

Dead reckoning can be used to track positional data, which can alter the virtual environment by updating motion changes of the user. The dead reckoning update rate and prediction algorithm used in a virtual reality system affect the user experience, but there is no consensus on best practices as many different techniques have been used. It is hard to rely only on inertial tracking to determine the precise position because dead reckoning leads to drift, so this type of tracking is not used in isolation in virtual reality. A lag between the user's movement and virtual reality display of more than a defined time (e.g., 100 milliseconds) has been found to cause nausea.

Inertial sensors are not only capable of tracking rotational movement (roll, pitch, yaw), but also translational movement. These two types of movement together are known as the Six degrees of freedom. Many applications of virtual reality need to not only track the users' head rotations, but also how their bodies move with them (left/right, back/forth, up/down). Six degrees of freedom capability is not necessary for all virtual reality experiences, but it is useful when the user needs to move things other than their head.

Sensor fusion can combine data from several tracking algorithms and can yield better outputs than only one technology. One of the variants of sensor fusion is to merge inertial and optical tracking. These two techniques are often used together because while inertial sensors are optimal for tracking fast movements and can accumulate errors quickly, and optical sensors offer absolute references to compensate for inertial weaknesses. Further, inertial tracking can offset some shortfalls of optical tracking. For example, optical tracking can be the main tracking method, but when an occlusion occurs inertial tracking estimates the position until the objects are visible to the optical camera again. Inertial tracking could also generate position data in-between optical tracking position data because inertial tracking has higher update rate. Optical tracking also helps to cope with a drift of inertial tracking. Combining optical and inertial tracking has shown to reduce misalignment errors that commonly occur when a user moves their head too fast. Micro electrical magnetic systems advancements have made magnetic/electric tracking more common due to their small size and low cost.

Acoustic tracking systems use techniques for identifying an object or device's position similar to those found naturally in animals that use echolocation. Analogous to bats locating objects using differences in soundwave return times to their two ears, acoustic tracking systems in VR may use sets of at least three ultrasonic sensors and at least three ultrasonic transmitters on devices in order to calculate the position and orientation of an object (e.g., a handheld controller). There are two ways to determine the position of the object: to measure time-of-flight of the sound wave from the transmitter to the receivers or the phase coherence of the sinusoidal sound wave by receiving the transfer.

Time-of-flight methods can use a set of three noncollinear sensors (or receivers) with distances between them d1 and d2, as well as the travel times of an ultrasonic soundwave (a wave with frequency greater than 20 kHz) from a transmitter to those three receivers, the relative Cartesian position of the transmitter can be calculated as follows:

$${x}_{0} = \frac{{l}_{1}^{2} + {d}_{1}^{2} - {l}_{2}^{2}}{2 {d}_{1}}$$

$${y}_{0} = \frac{{l}_{1}^{2} + {d}_{2}^{2} - {l}_{3}^{2}}{2 {d}_{2}}$$

$${z}_{0} = \sqrt{{l}_{1}^{2} - {x}_{0}^{2} - {y}_{0}^{2}}$$

Here, each li represents the distance from the transmitter to each of the three receivers, calculated based on the travel time of the ultrasonic wave using the equation l=Ctᵤₛ. The constant c denotes the speed of sound, which is equal to 343.2 m/s in dry air at temperature 20° C. Because at least three receivers are required, these calculations are commonly known as triangulation.

Beyond its position, determining a device's orientation (i.e., its degree of rotation in all directions) requires at least three noncollinear points on the tracked object to be known, mandating the number of ultrasonic transmitters to be at least three per device tracked in addition to the three aforementioned receivers. The transmitters emit ultrasonic waves in sequence toward the three receivers, which can then be used to derive spatial data on the three transmitters using the methods described above. The device's orientation can then be derived based on the known positioning of the transmitters upon the device and their spatial locations relative to one another.

B. Loading AR Environments from Memory (e.g., a Database)

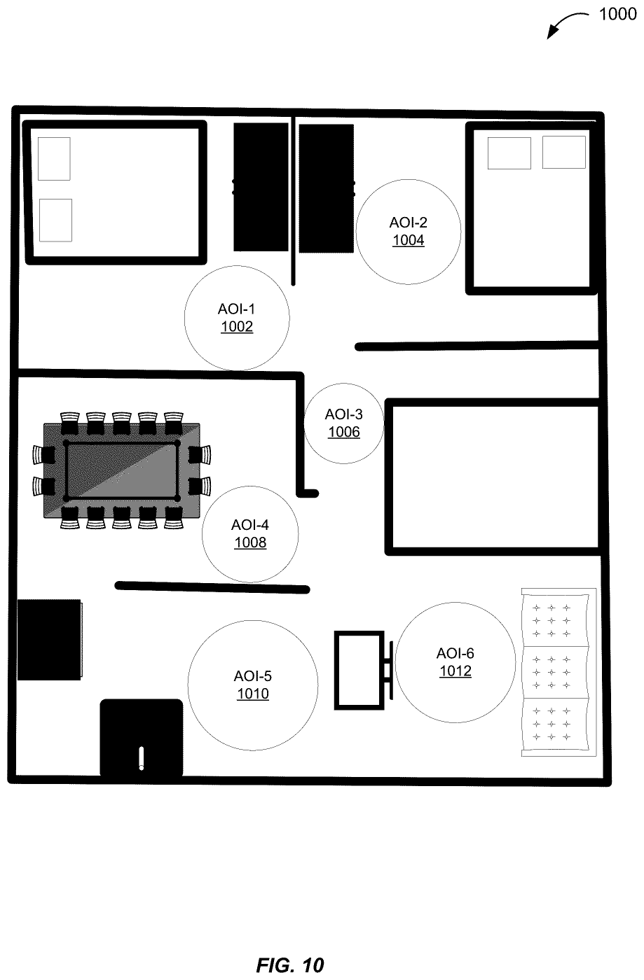

A user can create an AR map using a mobile application. The mobile application can use the mobile device camera to define the boundaries of the AR map. The mobile application can use images from the camera from the mobile device and generate virtual representations of objects in the image and place them in the AR map generated by the map. The map can be stored in a memory. In various embodiments, the map can be stored on a server. FIG. 10 illustrates an exemplary AR map 100 of a residence. The residence can include a kitchen, dining room, living room, and two bedrooms. Various AR areas can be defined in the AR map 1000. Various AR areas can include but are not limited to a first bedroom area (AOI-1) 1002, a second bedroom area (AOI-2) 1004, a hallway area (AOI-3) 1006, a dining room area (AOI-4) 1008, a kitchen area (AOI-5) 1010 and a living room area 1012. Other areas can be defined.

The AR map 1000 can be stored in the memory of the mobile device. In various embodiments, the AR map 1000 can be uploaded from a server via a network (e.g., the Internet).

Simultaneous localization and mapping (SLAM) techniques can be used to build a map of the environment (e.g., the bedroom) and localize the user in that map at the same time. SLAM algorithms allow the mobile device to map out unknown environments.

Visual SLAM (or vSLAM) uses images acquired from cameras and other image sensors. Visual SLAM can use simple cameras (e.g., wide angle, fisheye, and spherical cameras), compound eye cameras (stereo and multi cameras), and RGB-D cameras (depth and ToF cameras). Visual SLAM can be implemented at low cost with relatively inexpensive cameras. In addition, since cameras provide a large volume of information, they can be used to detect landmarks (previously measured positions). Landmark detection can also be combined with graph-based optimization, achieving flexibility in SLAM implementation.

Monocular SLAM is when vSLAM uses a single camera as the only sensor, which makes it challenging to define depth. This can be solved by either detecting AR markers, checkerboards, or other known objects in the image for localization or by fusing the camera information with another sensor such as inertial measurement units (IMUs), which can measure physical quantities such as velocity and orientation. Technology related to vSLAM includes structure from motion (SfM), visual odometry, and bundle adjustment.

SLAM techniques can use landmarks or areas of interest (AOI) to minimize localization errors. Using previous mapping techniques the mobile device can detect when the mobile device was near an AOI and can identify which AOI of a plurality of AOIs (e.g., in a house) that the mobile device is nearby. However, a user will need to manually turn on the sensors to perform localization techniques within the AOI. Additionally, the user will need to manually turn off the sensors as the mobile device is leaving the AOI.

AOI (AR Bubble) creation can involve several technical steps. A location manager module can activate optical and inertial sensors to provide precise position information for the mobile device. The location manager module can update heading information (from heading information from the compass of the mobile device) to determine mobile device's azimuth relative to true north, The AR kit module can begin visual SLAM world mapping including geometry-based plane detection of the area to define the AOI (or AR Bubble). The AR kit and scene kit module can add augmentation (e.g., spatialized audio or video content) to the AOI. The user interface can be used to store the AOI to the world map. The stored information for the AOI can include latitude, longitude, altitude information provided by the location manager as well as absolute altitude and accuracy of the time.

### C. Tracking Positions of Device Relative to Areas of Interest

Various positioning techniques can be used to automatically detect when the mobile device's trajectory is predicted to take it within an AOI and then automatically turn on the sensors. These techniques can include pedestrian dead reckoning (PDR), wireless ranging, GNSS signals, acoustic techniques, and use of microlocations derived from wireless signals (e.g., Wi-Fi, Bluetooth, Bluetooth Low Energy, etc.) In these techniques, the point of origin of the AR world can be the center for a geo-fence. The geo-fence can be a predetermined distance around a point. The positioning techniques can be used to determine when the mobile device moved more than then predetermined distance. If the mobile device is outside of an AR area and the sensors detect that the mobile device is on a trajectory to enter the AR area, the mobile device can load the AR map 1000 for the area and initiate the sensors (e.g., optical and/or inertial sensors). When the mobile device is inside an AR area and is on a trajectory to exit geo-fence the sensors can be turned off thereby conserving limited power resources for the mobile device. The positioning techniques can also be used to detect approaching a second AOI and again turn on the sensors once inside the second AOI.

These techniques allow for pausing the sensor (e.g., the camera) collection. In various embodiments the sensor collection can be reduced to a low rate of collection (e.g., 1 Hertz). The techniques also can pause the Visual SLAM session and/or the augmented reality session until the predicted trajectory indicates that the mobile device is on a path to enter an AOI. The positioning techniques allow for a low power technique for determining movement between AOI. However, a single positioning techniques (e.g., PDR) alone may not provide sufficient resolution to determine which AOI of a plurality of AOIs the mobile device trajectory is heading for. Therefore, the various positioning techniques (e.g., GNSS and wireless ranging) can be combined with geo-fences that determine when the mobile device has moved a predetermined distance. Combing various positioning techniques allow improved resolution of determining position and trajectory towards an AOI.

### D. Entering AR Area

Previous AR techniques could detect when the mobile device was near an AOI. However, manual user interface inputs were required to begin an AR session and initiate sensors for the session. This manual interaction also had lag in the localization of the mobile device in the AR area because the sensors needed time to receive inputs and calculate the precise position of the mobile device within the area. The following techniques describe using positioning techniques to automate the localization process and reduce lag resulting in an improved user experience.

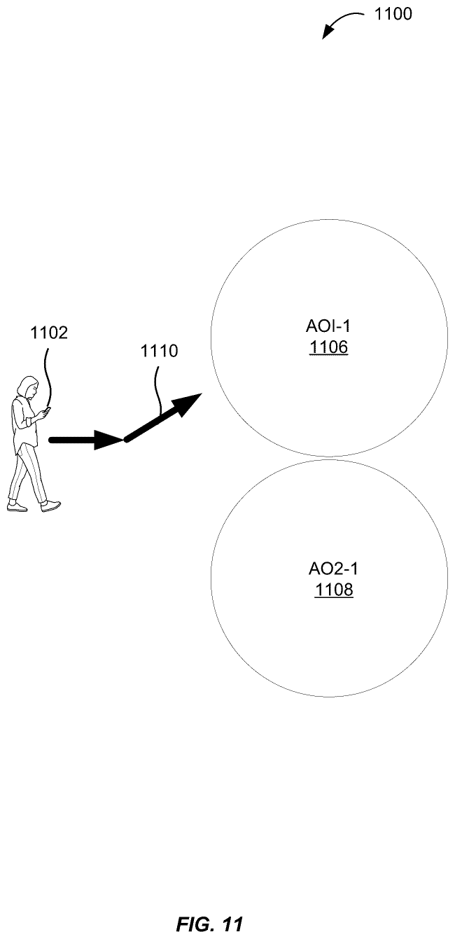

FIG. 11 illustrates an illustration of a map 1100 of one potential use of positioning techniques for entry into an AR area The map 1100 illustrates a location of the mobile device 1102 and a trajectory of the mobile device 1104 based on the detected motion of the mobile device 1102. There are two potential AOIs that the mobile device 1102 can be predicted to enter, such as a first AOI 1106 and a second AOI 1108. Without using PDR techniques, there can be lag in the AR system determining an AOI to localize against. If the trajectory of the device changes such as in the second trajectory 1110, the system can resolve the ambiguity and begin to localize for the first AOI 1106. As the mobile device 1102 crosses the geo-fence, the sensors can be activated to begin collecting and analyzing sensor data and ready to begin localization techniques for the first AOI 1106. By activating the sensors and collecting data early, these techniques can reduce lag from previously used manual techniques.

AOI (AR Bubble) entry can involve several technical steps. Prior to AOI entry the location module in the mobile device can be initiated to provide precise position information. The location module can be a combination of hardware (e.g., optical sensors, inertial sensors, GNSS sensors, camera, compass, accelerometers, wireless sensors) and software code that can determine a precise location of the mobile device. The location module can begin by updating heading information for the mobile device's azimuth relative to true north. The mobile device can load saved AOI file (ARBubbles) to active memory. The mobile device can begin coarse sorting AOI files (ARBubble) by “nearest” AOI as determined by coarse location from location module. The location module can begin updating the motion of the mobile device including representing attitude (true north reference), rotation rate, gravity, and user acceleration. The mobile device can calculate the predictive trajectory of the mobile device based on three points of motion updates and heading information. The mobile device can begin fine sorting AOI (ARBubble) locations based on positioning techniques. Once fine sorting has identified candidate ARBubble, an augmented reality module can begin visual SLAM techniques to enable world map relocalization. The sensors can be turned on at this point. Once world has relocalized, the mobile device can load augmented content. Once augmented content is loaded, the mobile device can set geo-fences and “world center” of the AOI (ARBubble).

### E. Exiting AR Area

AOI (ARBubble) location sorting can be suspended, and the user engages inside the AOI (ARBubble). As the mobile device exits the AOI (AR Bubble) the mobile device can use the various positioning features to maintain tracking of the mobile device inside the AOI (ARBubble) within the limits of the geo-fence. Once the mobile device has exited the geo-fence the (ARKit) ARBubble session is paused, and the sensors are turned off. The mobile device can return to a AOI “Bubble Entry” state, with sorting, until the system is turned off/exited via user interface engagement.

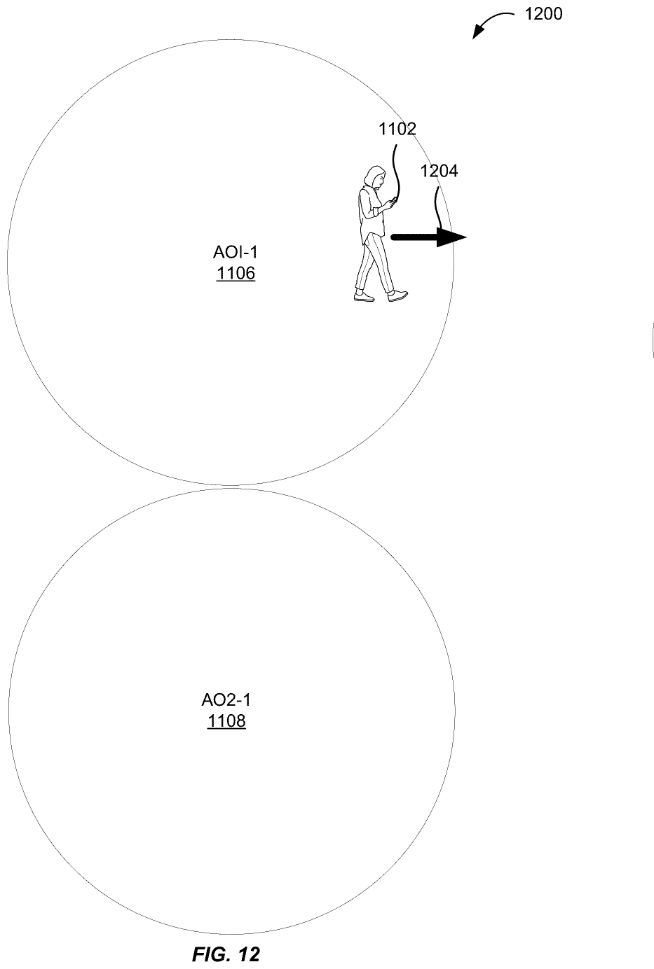

FIG. 12 illustrates an exemplary map 1200 of a user existing an AR area. The map 1200 illustrates a location of the mobile device 1102 and a trajectory 1204 of the mobile device 1102 based on the detected motion of the mobile device 1102. In FIG. 12, the trajectory 1204 shows that the mobile device is about to leave a first AOI 1106.

Previous techniques could not detect when the mobile device had exited the AOI, and the sensors and AR kit would continue localization techniques until manually deactivated by the user. By using the various positioning techniques, the mobile device applications can determine when the mobile device 1102 has traveled a predetermined distance (e.g., 3 or 4 meters) to exit the AR area. As the mobile device exits the AR area, power can be removed from the sensors (e.g., the optical and inertial sensors), precise positioning techniques can be paused or turned off thereby conserving power resources for the mobile device battery.

An initial trigger for AR localization using visual SLAM techniques can originate from a core location. The core location can be from a GPS position, Wi-Fi SLAM techniques, microlocation, UWB ranging or another localization technique.

### F. Example Use of AR Positioning Techniques

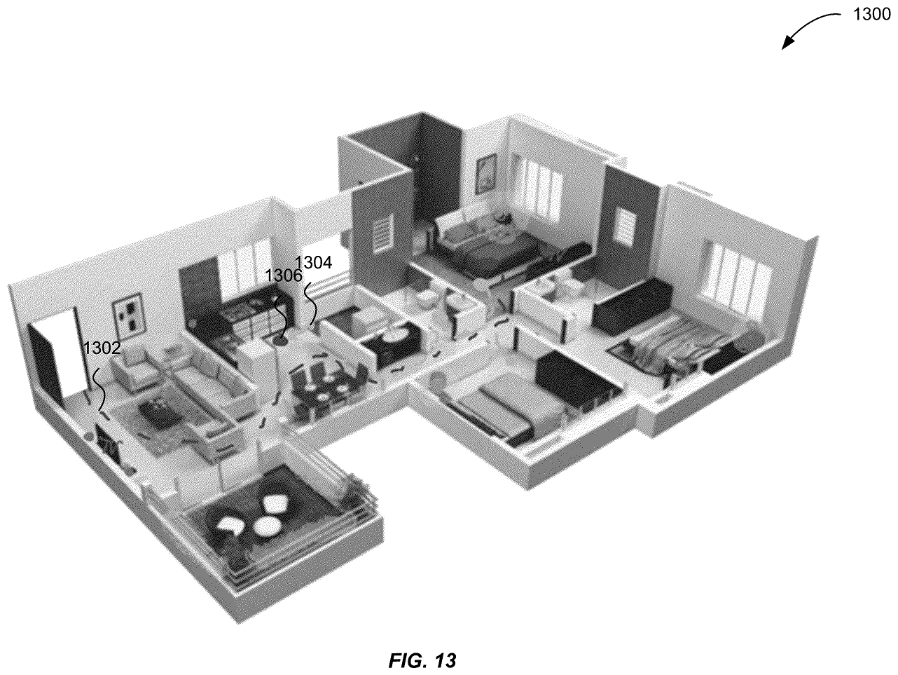

FIG. 13 illustrates a second map 1300 of a residence. The PDR techniques can use to determine a first path 1302 of a first mobile device of a first user and a second path 1302 of a second mobile device of a second user. The identified points 1306 can identify known areas (e.g., a kitchen, a bedroom, a bathroom, etc.) in the second map 1300. The identified point 1306 can be mapped into a coordinate space as AOIs or AR bubbles.

A location manager module can be pre-warmed to provide precise position information for the mobile device. The location manager module can update heading information (from heading information from the compass of the mobile device) to determine mobile device's azimuth relative to true north. The AR kit module can begin visual SLAM world mapping including geometry-based plane detection of the area to define the AOI (or AR Bubble). The AR kit and scene kit module can add augmentation (e.g., spatialized audio or video content) to the AOI. The user interface can be used to store the AOI to the world map. The stored information for the AOI can include latitude, longitude, altitude information provided by the location manager as well as absolute altitude and accuracy of the time.

### G. Flow for Positioning Techniques for Augmented Reality

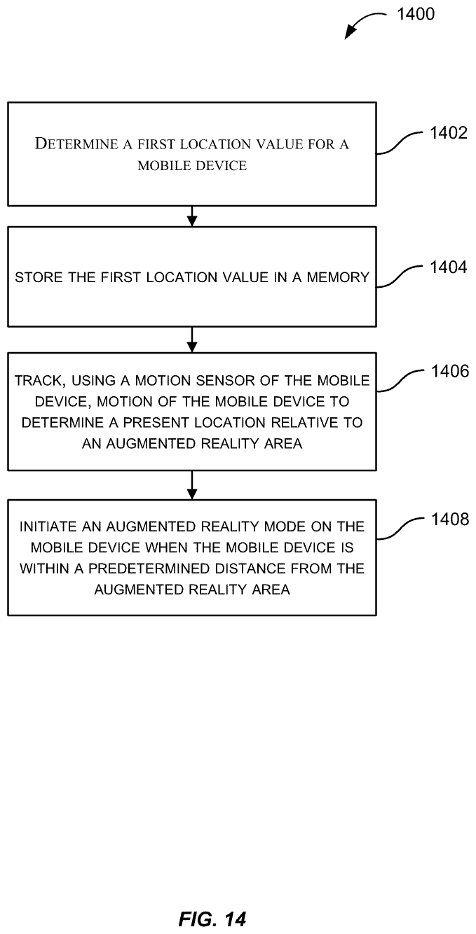

FIG. 14 is a flow chart of a process 1400 for using positioning techniques to determine when a mobile device trajectory is predicted to enter an Area of Interest (AOI) according to an example of the present disclosure. According to an example, one or more process blocks of FIG. 14 may be performed by a mobile device (e.g., a wearable device, a smartphone, a tablet computer, a laptop computer).

At block 1402, responsive to a trigger signal at an associated first time, process 1400 may include determining a first location value for a mobile device. For example, the mobile device may determine a first location value for the mobile device using one or more of GNSS (e.g., GPS timing signals), microlocation determination, wireless ranging sessions, RSSI determination from one or more transmitting devices.

At block 1404, process 1400 may include storing the first location value in a memory. For example, the mobile device may store the first location value in a local memory of the mobile device. In various embodiments, the mobile device can store the first location in a memory of a cloud-based server device.

At block 1406, process 1400 may include tracking, using a motion sensor of the mobile device, motion of the mobile device to determine a present location relative to an augmented reality area. For example, device may track, using a motion sensor of the mobile device, motion of the mobile device to determine a present location relative to an augmented reality area, as described above.

At block 1408, process 1400 may include initiating an augmented reality mode on the mobile device when the mobile device is within a predetermined distance from the augmented reality area. The predetermined distance can vary depending on the desired size of the AOI. In various embodiments the predetermined distance can be between 1 meter and 7 meters. For example, the mobile device may initiate an augmented reality mode on the mobile device when the mobile device is within a predetermined distance from the augmented reality area, as described above.

Process 1400 may include additional implementations, such as any single implementation or any combination of implementations described below and/or in connection with one or more other processes described elsewhere herein. A first implementation, process 1400 may include capturing sensor data using a second sensor on the mobile device and storing the sensor data in the memory.

In various embodiments, process 1400 may include pausing the augmented reality mode on the mobile device when the present location of the mobile device is outside the augmented reality area (such as an AOI or AR bubble). In various embodiments, the pausing the augmented reality mode can include deactivating, powering down, or changing the detection rate of one or more of the sensors of the mobile device that can be used for localization.

In various embodiments, process 1400 further includes tracking, using the motion sensor of the mobile device, motion of the mobile device to determine a trajectory of the mobile device; initiating an augmented reality mode when the trajectory of the mobile device will be within a predetermined range from the augmented reality area.

In various embodiments, process 1400 may include pausing the augmented reality mode on the mobile device when the trajectory of the mobile device is outside the augmented reality area. In various embodiments, the pausing the augmented reality mode can include deactivating, powering down, or changing the detection rate of one or more of the sensors of the mobile device that can be used for localization.

It should be noted that while FIG. 14 shows example blocks of process 1400, in some implementations, process 1400 may include additional blocks, fewer blocks, different blocks, or differently arranged blocks than those depicted in FIG. 14. Additionally, or alternatively, two or more of the blocks of process 1400 may be performed in parallel.

It should be appreciated that the specific steps illustrated in FIG. 14 provide a particular method of predicting actions according to some embodiments. Other sequences of steps may also be performed according to alternative embodiments. For example, alternative embodiments of the present invention may perform the steps outlined above in a different order. Moreover, the individual steps illustrated in FIG. 14 may include multiple sub-steps that may be performed in various sequences as appropriate to the individual step. Furthermore, additional steps may be added or removed depending on the particular applications. One of ordinary skill in the art would recognize many variations, modifications, and alternatives.

### VIII. Proximity Determination Using Stored Sensor Locations

Detecting device proximity can be done using the contemporaneous exchange of ranging messages between proximate devices. These messages are exchanged if both devices are active, near each other, and share a common message protocol. Accordingly, these contemporaneous techniques cannot be used to detect a proximate device that is out of battery, fails to synchronize, cannot support ranging measurements, or is otherwise offline.

According to some embodiments of the present disclosure, devices can use a sensor position (e.g., as described above in Sections I and II) to non-contemporaneously determine device proximity without directly exchanging messages. A signal fingerprint can include a set of electromagnetic signal measurements (e.g., a set of sensor values) that a device takes with nearby anchors (e.g., signal sources). The signal fingerprint (e.g., a sensor position) can include a list of detected signal sources (e.g., Wi-Fi access points) and a distance measurement (e.g., a time-of flight or the received signal strength indicator (RSSI)) for each signal source. Such signal sources can be referred to as anchor devices. A first mobile device can upload signal fingerprints to a server, e.g., at regular intervals or in response to a trigger event, such as paring with a device or detecting low battery. A signal fingerprint can include the set of sensor values and corresponding anchor identifies for the corresponding anchor devices.

A second device can use the stored sensor position (also referred to as signal fingerprint) of one or more first devices in various ways. For example, action(s) by a first user of the first device(s) at previous location(s) can be used to predict an action that a second user might take when the second device is at a similar location. An action could include suggesting a device to pair with, e.g., for sending content to play such as audio or video. As another example, the second device can lead a user to find the first device, e.g., when the first device's battery has run out, so the first device is no longer responsive. Such are examples of a proximity classification.

To determine a current or previous location of the first device, a second device can retrieve a signal fingerprint from the server. The fingerprint can be retrieved in response to a request that may include a device identifier associated with a previously generated fingerprint (e.g., a fingerprint generated by a lost device associated with the device identifier). The second device can determine its own signal fingerprint and provide this fingerprint, and the retrieved fingerprint, as input to a similarity function. The output of the similarity function can be used to determine whether two sensor positions are similar enough to provide a proactive suggestion (e.g., an application or an action of an application) or point the user of the second device to the first device. Such steps can also be performed by the server to make the determination of a proximity classification.

As examples, the similarity function can translate the sensor positions' similarity into a probability of spatial proximity (e.g., a probability that the two devices are within a specified distance of each other) or potentially into a distance vector. If the probability is above a threshold, the second device can designate the first device as a proximate device. This threshold can depend on the ranging technique used to calculate the distance. For instance, received signal strength indicator (RSSI) measurements can be less accurate than time of flight measurements so the threshold may have a smaller magnitude for time-of-flight measurements when compared to RSSI measurements.

The similarity function can be a function that compares the cartesian distance to each anchor between two fingerprints. If the difference between the distances to each anchor is within a threshold, the two fingerprints can be categorized as near each other. The cartesian distance between two anchors in a three-dimensional space can be given with the following formula:

$$d ( p , q ) = \sqrt{{( {p}_{x} - {q}_{x} )}^{2} + {( {p}_{y} - {q}_{y} )}^{2} + {( {p}_{z} - {q}_{z} )}^{2}}$$

Where p and q are points on a three-dimensional coordinate system with mutually perpendicular axes.

As another example, the similarity function can determine the cosine similarity between vectors in each fingerprint. The vectors in a fingerprint can be a vector from a device to an anchor with one vector for each anchor. The cosine similarity is the cosine of the angle between two vectors and the cosine similarity can vary from −1 (if two vectors are opposites), 0 for perpendicular vectors, and 1 for identical vectors. The cosine similarity can be calculated for each anchor device summed. If the sum is below a threshold, the two fingerprints can be classified as corresponding to the same location. Cosine similarity can be calculated with the following formula:

$$cos θ = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}}$$

Where A and B are vectors and Aᵢ and Bᵢ are the i^{th} components of vectors A and B, respectively.

The similarity function may compare the list of anchors and signals in two fingerprints. For example, each fingerprint can include a list signals from anchors with unique identifiers. These lists can be compared to each other to identify the hamming distance between each list. A hamming distance is the minimum number of substitutions to change a first list into a second list. For example, fingerprint 1 can be (A1, A2, A3, A4, and A5) and fingerprint 2 can be (A1, B1, A3, A4, and B2). In this example, the hamming distance is 2 because swapping A2 with B2 and A5 with B2 is sufficient to change fingerprint 1 into fingerprint 2. In addition to the techniques described above, the similarity function can include any combination of the techniques described above. For instance, the similarity function may be a weighted sum of the Euclidean distance, cosine similarity, and hamming distance between two fingerprints.

### A. Obtaining and Storing First Sensor Position

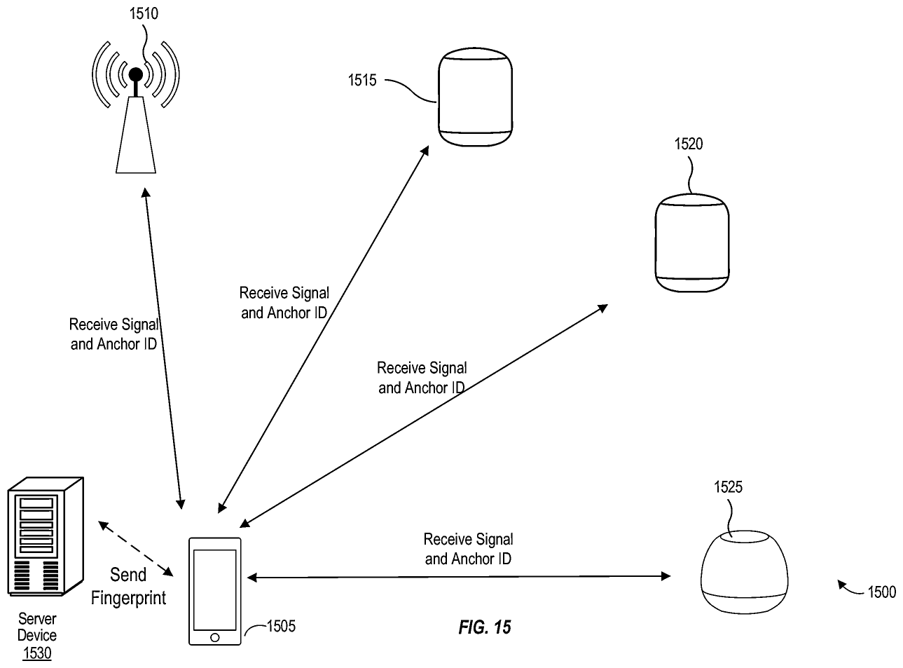

FIG. 15 illustrates a simplified block diagram 1500 of a first mobile device obtaining a fingerprint at a first time period according to various embodiments. Mobile device 1505 can be any suitable computing device (e.g., smartphone, smartwatch, laptop computer, tablet computer, etc.). Communications software executing on mobile device 1505 can detect signals received at sensors of the mobile device, and these detected signals can be used to generate a fingerprint (e.g., a sensor position) for the first time period.

The fingerprint can include a list of detected signal sources (e.g., Wi-Fi access points) and a distance measurement (e.g., a time-of flight or the received signal strength indicator (RSSI)) for each signal source (e.g., anchor device). The list of detected signal sources (anchor devices) can include anchor identifiers to differentiate the anchor devices from each other. The signal sources can be detected through wireless signals received at the mobile device 1505 during a time period (e.g., a set of sensor values), as described elsewhere in this disclosure. The time period can be 1 millisecond, 10 milliseconds, 50 milliseconds, 100 milliseconds, 0.5 seconds, 1 second, 5 seconds, 10 seconds, 30 seconds, 1 minute, 5 minutes, 15 minutes, and 1 hour. The wireless signals can include any wireless electromagnetic signals, and, for instance, the wireless signals can include personal area network signals (e.g., Bluetooth low energy (BLE) signals) or Local Area Network signals (e.g., Wi-Fi signals).

The wireless signals can be received at mobile device 1505 from anchor devices 1510-1525. The wireless signals are illustrated as double headed arrows in diagram 1500, and the wireless signals can include an electromagnetic signal and an anchor identifier for the anchor device that transmitted the signal. The electromagnetic signal may be a ranging measurement in some embodiments. The ranging signals can include a time of flight measurement (e.g., a measurement of the time a message takes to travel between mobile device 1505 and one of anchor devices 1510-1525), or a received signal strength indicator (RSSI) (e.g., a measurement of the strength of the wireless signal received at mobile device 1505 from one of anchor devices 1510-1525).

The anchor identifier can be a unique identifier that was assigned to the anchor device by the device manufacturer or a device user. For example, the anchor identifier can be a service set identifier (SSID) for a Wi-Fi access point or a Bluetooth advertiser address. As another example, e.g., if a user labels the anchor devices, a geographical location (e.g., as determined using GPS) can be used as part of the identifier, so as to ensure a unique value among all anchor devices.

Accordingly, the fingerprint, can include information provided by mobile device 1505 such as a global positioning system (GPS) address measured by the mobile device. Including information measured by mobile device 1505 can reduce the likelihood that two anchor devices with the same or similar identifiers are conflated (e.g., a name such as “Home Network” could be the SSID for multiple anchor devices in different locations). The information can also reduce the search space if the mobile device 1505 retrieves a fingerprint from (e.g., only fingerprints generated within a threshold distance of a particular GPS address are retrieved).

The set of sensor values in a fingerprint can be organized by identifiers, and, for example, sensor values for device 1505 can be associated with a SSID for anchor device 1510 and the sensor values for anchor devices 1515-1525 can be associated with a list of Bluetooth advertiser addresses for anchor devices 1515-1525. As mentioned above, the combination of the sensor values measured at a particular location can be a sensor position (e.g., a fingerprint). Measured sensor values can vary between locations and the sensor values can be used to determine if two sets of sensor values were measured at the same location. The fingerprint can be an average of sensor values measured during a time period or a snapshot of sensor measurements taken at a point in time. Table 1 depicts example sensor values with a single Wi-Fi access point and a single Bluetooth device. The identifier types and sensor values can vary as shown in table 1 below:

TABLE 1

| Identifier | | | |
|---|---|---|---|
| | Bluetooth Advertiser | Sensor Value | |
| SSID | Address | RSSI | Time-of-Flight |
| Home Network | N/A | 0.3333 | N/A |
| N/A | 07:1A:10:7F:11:00 | 0.4742 | 0.1 milliseconds |

Mobile device 1505 can upload a fingerprint, or a sensor set, to server device 1530. The uploaded fingerprint, or sensor set, is illustrated as a double headed dashed arrow between mobile device 1505 and server device 1530. The mobile device 1505 may upload the fingerprint at regular intervals (e.g., every 5 min) or in response to an event. For example, mobile device 1505 may upload the fingerprint, or sensor set, in response to a low battery indication, in response to opening the Bluetooth settings, or receiving user input to a streaming service.

### B. Obtaining Second Sensory Position and Retrieving First Sensor Position

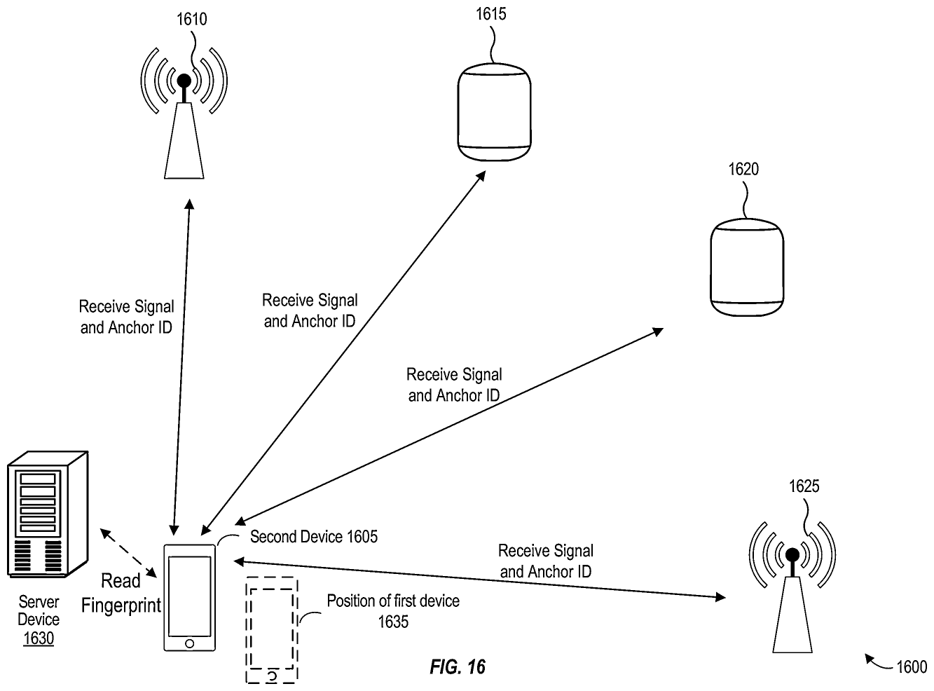

FIG. 16 illustrates a simplified block diagram 1600 of a second mobile device obtaining a second fingerprint at a second time period according to various embodiments. Mobile device 1605 can be any suitable computing device (e.g., smartphone, smartwatch, laptop computer, tablet computer, etc.). The fingerprint from diagram 1600 can be measured at the location depicted in 1500. However, diagram 1500 depicts a first time period and diagram 1600 depicts a second time period. The first mobile device's previous location 1635 is indicated to demonstrate that the two mobile devices are located in a similar area.

Mobile device 1605 can measure a set of sensor values received from anchor devices to generate a fingerprint (e.g., sensor position). The set of anchor devices for which a sensor position is determined can vary between time periods if a new anchor is added or removed from a location after one fingerprint is generated and before a second fingerprint is obtained. In addition to adding or removing devices, the identifier for an anchor may be changed, and, for example, the SSID for a Wi-Fi access point can change if the access point is renamed by a user. Additionally, an anchor, such as a Bluetooth enabled speaker, may be moved which can change the sensor values that are received from that anchor device. It is not necessary to have a perfect correspondence between devices at each time period and device proximity can be determined even if the anchor devices change between time periods. However, at least two anchor device should be present, identifiable, and at similar locations during both time periods.

In this case, anchor devices 1610-1620 were present during the first time period (e.g., anchor devices 1510-1620). However, anchor device 1525 is not present at the second time period depicted in diagram 1600 and anchor device 1625 was added after the first time period shown in diagram 1500. The removal of anchor device 1525 and the addition of anchor device 1625 can mean that the fingerprint generated by mobile device 1505 and the fingerprint generated by mobile device 1605 do not perfectly correspond because the sensor values for 1525 are absent from the fingerprint and the sensor values for 1625 are included in the fingerprint.

Mobile device 1605 can retrieve the fingerprint for the first mobile device 1505 from server device 1630. The fingerprint can be retrieved in response to a request that is sent to server device 1630 and the request can include one or more of a device identifier for the first mobile device 1505, a global positioning coordinate for the location depicted in FIG. 16, or the fingerprint generated by mobile device 1605. If the request includes the fingerprint, the server device 1630 can compare the fingerprints and return a proximity classification to mobile device 1605.

If the server returns the fingerprint generated by mobile device 1505, the mobile device 1605 can provide the fingerprint to a similarity model (e.g., a machine learning model) to determine if the two fingerprints correspond to the same location. Mobile device 1605 can determine that its fingerprint and the fingerprint generated by mobile device 1505 correspond to the same location because the sensor values generated by a threshold number of anchor devices, represented in the fingerprints, overlap (e.g., the sensor values are identified as similar by a similarity function). In addition to comparing the similarity of the received signals, the list of anchor devices in a fingerprint can be compared to determine a correspondence between the identifiers in each fingerprint. The number of matching anchor identifiers can be compared to a threshold to determine if the two fingerprints correspond to the same location, e.g., so their sensor positions can be compared to each other. The threshold number of anchor devices can be 1 device, 2 devices, 3 devices, 4 devices, 5 devices, 6 devices, 7 devices, 8 devices, 9 devices, 10 devices, 15 devices, or 20 devices. The threshold can be a threshold percentage of devices that overlap (e.g., 10%, 20%, 30%, 40%, 50%, 60%, 70%, 80%, and 90%).

Anchor devices 1610-1625, and anchor devices 1510-1515 are devices that broadcast electromagnetic signals and are associated with a location. For example, the anchor devices (e.g., signal sources) can be smart televisions, streaming devices, smart home appliances (e.g., lights, speakers, ovens, refrigerators, locks, security systems, and the like), wireless access points, desktop computers, or printers. However, some devices can broadcast signals but are not associated with a particular location. For example, smartphones, smartwatches, laptop computers, tablet computers, headphones, or portable wireless access points.

Mobile device 1605 can distinguish between devices that are primarily static or mobile devices using a unique identifier or serial number in the payload of signals received at mobile device 1605. For instance, mobile device 1605 may exclude headphones from a fingerprint while retaining a wireless speaker. Excluding mobile devices while retaining static devices can help improve the reliability of proximity classifications by excluding devices that are not primarily associated with a location.

### C. Examples Flows for Determining Proximity Classification

Proximity classifications can be determined locally at a mobile device, or the proximity classification can be determined at a server. The proximity classification is determined by inputting fingerprints into a similarity model that determines whether the input fingerprints are similar. This similarity model can execute on a mobile device or on a server device.

### 1. Flow for Detecting Device Proximity at a Mobile Device

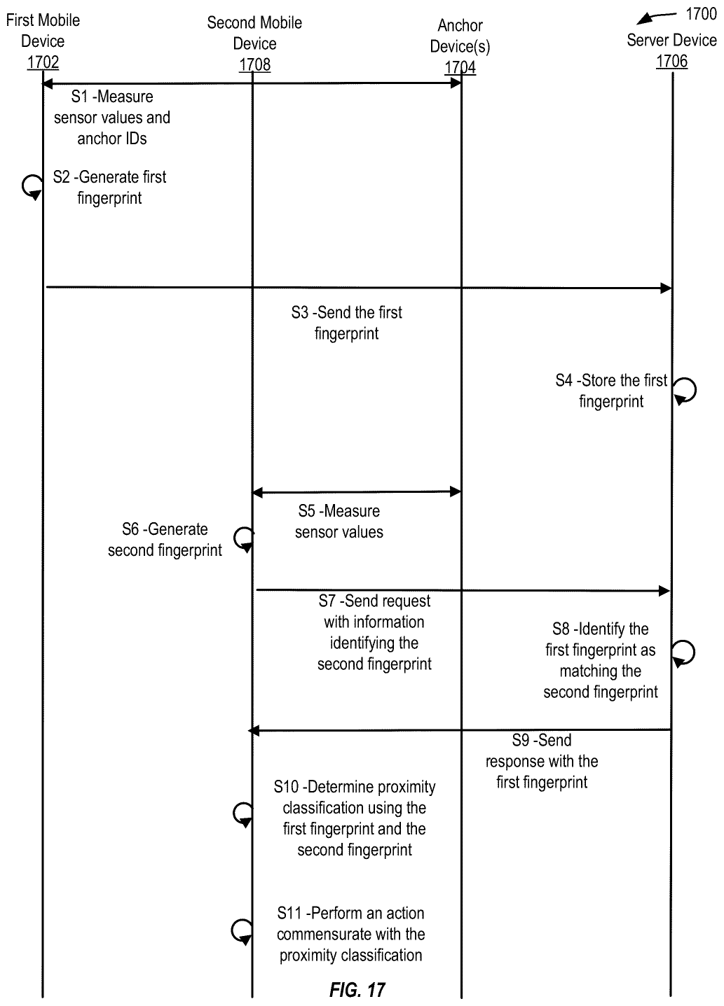

FIG. 17 is a swim lane diagram 1700 depicting techniques for detecting device proximity at a mobile device according to some embodiments.

At S1 a first mobile device 1702 can measure the sensor values and obtain the anchor identifier of one or more anchor device(s) 1704. Measuring the sensor values can mean that ranging measurements are exchanged between first mobile device 1702 and anchor device(s) 1704, or first mobile device 1702 can measure electromagnetic signals broadcast by anchor devices 1704. The sensor values can include unique identifiers for some or all of anchor devices 1704.

At S2, the first mobile device 1702 can generate a first fingerprint using the sensor values measured at S1. Generating the first fingerprint can include excluding one or more of the sensor values measured at S1, associating the sensor values with unique identifiers for anchor devices 1704, and recording actions taken by the first mobile device 1702 during a period of time before the sensor values were measured.

At S3, the first fingerprint can be sent to a server device 1706. The first fingerprint can be sent to the server device 1706 via a network connection. The server device 1706 can be one or more network accessible computing devices. At S4, server device 1706 can store the first fingerprint. The first fingerprint can be stored with a unique identifier for the first mobile device 1702.

At S5 a second mobile device 1708 can measure the sensor values and obtain the anchor identifier of one or more anchor device(s) 1704. Measuring the sensor values can mean that ranging measurements are exchanged between second mobile device 1708 and anchor device(s) 1704, or second mobile device 1708 can measure electromagnetic signals broadcast by anchor devices 1704. The sensor values can include unique identifiers for some or all of anchor devices 1704.

At S6, the second mobile device 1702 can generate a second fingerprint using the sensor values measured at S5. Generating the second fingerprint can include excluding one or more of the sensor values measured at S5, associating the sensor values with unique identifiers for anchor devices 1704, and recording actions taken by the second mobile device 1702 during a period of time before the sensor values were measured.

At S7, a request can be sent to the server device 1706. The request can include information that can identify the second fingerprint so that matching fingerprints in the server device's memory can be retrieved. The information identifying the second fingerprint can include the second fingerprint, one or more anchor identifiers from the second fingerprint, or a global positioning system (GPS) location captured contemporaneously with the second fingerprint. The request can be sent to the server device 1706 via a network connection. The server device 1706 can be one or more network accessible computing devices.

At S8, server device 1706 can identify the first fingerprint as a matching fingerprint. The server device 1706 can retrieving one or more fingerprints that correspond to the second fingerprint from the server's memory using the information identifying the second fingerprint. Theses retrieved fingerprints can include the first fingerprint generated at S2. The one or more fingerprints can be retrieved by comparing the second fingerprint, or information identifying the second fingerprint, to the fingerprints stored in server device 1706. If the request includes the second fingerprint, processing the request can mean storing the second fingerprint with a unique identifier for the second mobile device 1708.

At S9, a response to the request can be sent from server device 1706 to second mobile device 1708. In some embodiments, the second device can perform the proximity classification using the proximity function and the response can include one or more fingerprints identified at S8. The response may include information identifying one or more actions associated with each of the retrieved fingerprints. Actions can be associated with a fingerprint if the actions were performed by a mobile device during a time period before the mobile device generated the fingerprint. The actions can be used to suggest an action to the second mobile device. For example, if the first mobile device 1702 paired with a particular streaming device before generating the fingerprint at S2, the associated action can be used to identify the streaming device to the second mobile device 1708 as a suggested pairing device. Suggested actions are described in more detail below in section VIII.E “Use Cases.”

At S10, second mobile device 1708 can determine a proximity classification using the first fingerprint and the second fingerprint. Determining the proximity classification can include providing the first fingerprint and the second fingerprint as input to a similarity model, and the similarity model can output a classification.

At S11, the second mobile device 1708 can perform an action commensurate with the proximity classification determined at S11. An action commensurate with the proximity classification can include presenting a distance between the location where the first fingerprint and the second fingerprint were generated. In addition, processing the response may include presenting the one or more actions identified at S9 via a user interface or performing the identified actions.

### 1. Flow for Detecting Device Proximity at a Server Device

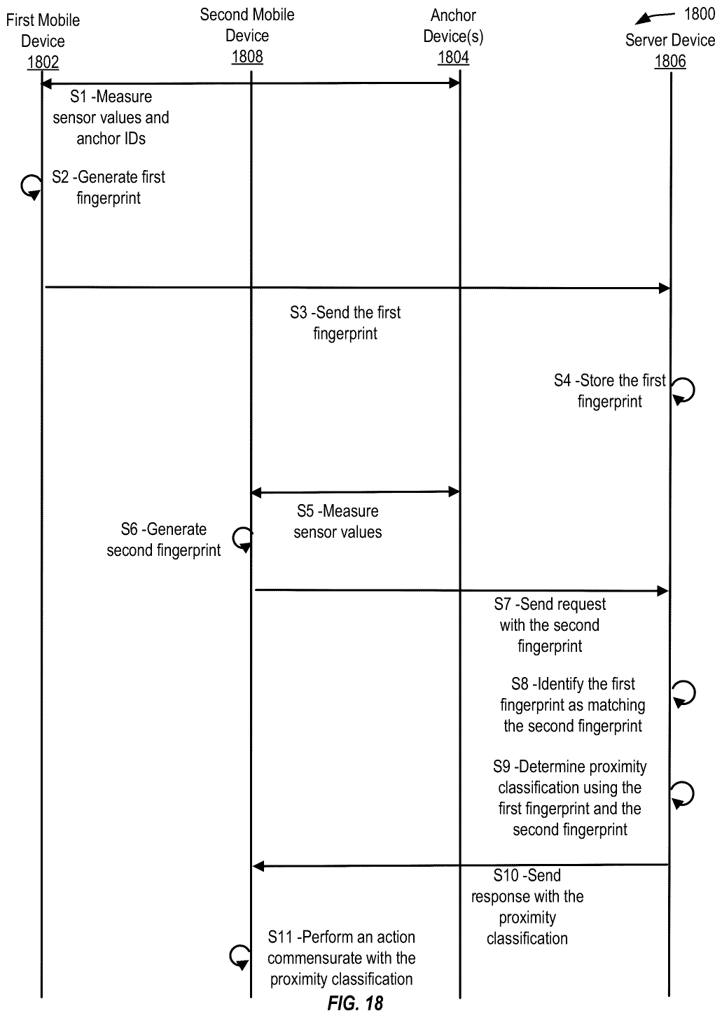

FIG. 18 is a swim lane diagram 1800 depicting techniques for detecting device proximity at a server device according to some embodiments.

At S1 a first mobile device 1802 can measure the sensor values and obtain the anchor identifier of one or more anchor device(s) 1804. Measuring the sensor values can mean that ranging measurements are exchanged between first mobile device 1802 and anchor device(s) 1804, or first mobile device 1802 can measure electromagnetic signals broadcast by anchor devices 1804. The sensor values can include unique identifiers for some or all of anchor devices 1804.

At S2, the first mobile device 1802 can generate a first fingerprint using the sensor values measured at S1. Generating the first fingerprint can include excluding one or more of the sensor values measured at S1, associating the sensor values with unique identifiers for anchor devices 1804, and recording actions taken by the first mobile device 1802 during a period of time before the sensor values were measured.

At S3, the first fingerprint can be sent to a server device 1806. The first fingerprint can be sent to the server device 1806 via a network connection. The server device 1806 can be one or more network accessible computing devices. At S4, server device 1806 can store the first fingerprint. The first fingerprint can be stored with a unique identifier for the first mobile device 1802.

At S5 a second mobile device 1808 can measure the sensor values and obtain the anchor identifier of one or more anchor device(s) 1804. Measuring the sensor values can mean that ranging measurements are exchanged between second mobile device 1808 and anchor device(s) 1804, or second mobile device 1808 can measure electromagnetic signals broadcast by anchor devices 1804. The sensor values can include unique identifiers for some or all of anchor devices 1804.

At S6, the second mobile device 1802 can generate a second fingerprint using the sensor values measured at S5. Generating the second fingerprint can include excluding one or more of the sensor values measured at S5, associating the sensor values with unique identifiers for anchor devices 1804, and recording actions taken by the second mobile device 1802 during a period of time before the sensor values were measured.

At S7, a request can be sent to the server device 1806. The request can include information that can identify the second fingerprint so that matching fingerprints in the server device's memory can be retrieved by the server. The information identifying the second fingerprint can include the second fingerprint, one or more anchor identifiers from the second fingerprint, or a global positioning system (GPS) location captured contemporaneously with the second fingerprint. The request can be sent to the server device 1806 via a network connection. The server device 1806 can be one or more network accessible computing devices.

At S8, server device 1806 can identify the first fingerprint as a matching fingerprint. The server device 1806 can retrieving one or more fingerprints that correspond to the second fingerprint from the server's memory using the information identifying the second fingerprint. Theses retrieved fingerprints can include the first fingerprint generated at S2. The one or more fingerprints can be retrieved by comparing the second fingerprint, or information identifying the second fingerprint, to the fingerprints stored in server device 1806. If the request includes the second fingerprint, processing the request can mean storing the second fingerprint with a unique identifier for the second mobile device 1808.

At S9, server device 1806 can determine a proximity classification using the first fingerprint and the second fingerprint. Determining the proximity classification can include providing the first fingerprint and the second fingerprint as input to a similarity model, and the similarity model can output a classification. The similarity model can execute on server device 1806.

At S10, a response to the request can be sent from server device 1806 to second mobile device 1808. The response can include a proximity classification generated at S9. In addition, the response may include information identifying one or more actions associated with each of the retrieved fingerprints. Actions can be associated with a fingerprint if the actions were performed by a mobile device during a time period before the mobile device generated the fingerprint. The actions can be used to suggest an action to the second mobile device. For example, if the first mobile device 1802 paired with a particular streaming device before generating the fingerprint at S2, the associated action can be used to identify the streaming device to the second mobile device 1808 as a suggested pairing device. Suggested actions are described in more detail below in section VIII.E “Use Cases.”

At S11, the second mobile device 1808 can perform an action commensurate with the proximity classification determined at S11. An action commensurate with the proximity classification can include presenting a distance between the location where the first fingerprint and the second fingerprint were generated. In addition, processing the response may include presenting the one or more actions identified at S9 via a user interface or performing the identified actions.

### D. Systems for Detecting Device Proximity

Device proximity can be determined on a mobile device or on a server device. The proximity can be determined by inputting two fingerprints to a similarity model. Systems for determining device proximity on a mobile device and on a server device are described below.

### 1. System for Detecting Device Proximity on a Mobile Device

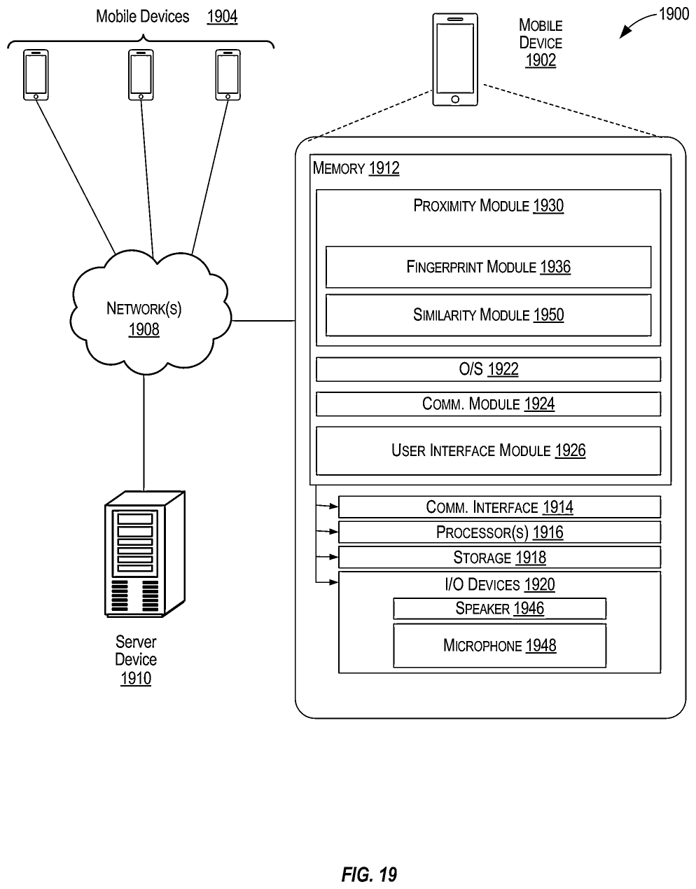

FIG. 19 is a simplified block diagram 1900 illustrating an example architecture of a system used to detect device proximity on a mobile device according to some embodiments. The diagram includes a representative mobile device 1902, one or more mobile devices 1904, one or more network(s) 1908, and a server device 1910. Each of these elements depicted in FIG. 19 may be similar to one or more elements depicted in other figures described herein.

The mobile devices 1904 may be any suitable computing device (e.g., smartphone, smartwatch, laptop computer, tablet computer, etc.). In some embodiments, a mobile device may perform any one or more of the operations of mobile devices described herein. Depending on the type of mobile device and/or location of the accessory device the mobile device may be enabled to communicate using one or more network protocols (e.g., a Bluetooth connection, a Thread connection, a Zigbee connection, a Wi-Fi connection, etc.) and network paths over the network(s) 1908 (e.g., including a LAN or WAN), described further herein.

In some embodiments, the server device 1910 may be a computer system that comprises at least one memory, one or more processing units (or processor(s)), a storage unit, a communication device, and an I/O device. In some embodiments, the server device 1910 may perform any one or more of the operations of server devices described herein. In some embodiments, these elements may be implemented similarly (or differently) than as described in reference to similar elements of mobile device 1902.

In some embodiments, the representative mobile device 1902 may correspond to any one or more of the computing devices described herein. The representative computing device may be any suitable computing device (e.g., a smart speaker, a mobile phone, tablet, a wireless speaker, a smart hub speaker device, a smart media player communicatively connected to a TV, etc.).

In some embodiments the one or more network(s) 1908 may include an Internet WAN and a LAN. For example, a router associated with a LAN may enable traffic from the LAN to be transmitted to the WAN, and vice versa. Mobile device 1902 or mobile devices 1904 may communicate with the WAN over a telecommunications network such as a broadband cellular network (e.g., 2G, 3G, 4G, 5G, or 6G telecommunications networks). In some embodiments, the server device 1910 may be external to the monitored environment, and thus, communicate with other devices over the WAN. For example, mobile device 1902 or mobile devices 1904 can transmit or retrieve signal fingerprints from the server device 1910. The signal fingerprints may be stored in the server device 1910, and the stored fingerprints may be associated with a geographic region, unique identifier, or a device identifier.

As described herein, mobile device 1902 may be representative of one or more computing devices connected to one or more of the network(s) 1908. The computing device 1902 has at least one memory 1912, a communications interface 1914, one or more processing units (or processor(s) 1916, a storage unit 1918, and one or more Input/Output (I/O) device(s) 1920.

Turning to each element of computing device 1902 in further detail, the processor(s) 1916 may be implemented as appropriate in hardware, computer-executable instructions, firmware, or combinations thereof. Computer-executable instruction or firmware implementations of the processor(s) 1916 may include computer-executable or machine executable instructions written in any suitable programming language to perform the various functions described.

The memory 1912 may store program instructions that are loadable and executable on the processor(s) 1916, as well as data generated during the execution of these programs. Depending on the configuration and type of computing device 1902, the memory 1912 may be volatile (such as random access memory (“RAM”)) or non-volatile (such as read-only memory (“ROM”), flash memory, etc.). In some implementations, the memory 1912 may include multiple different types of memory, such as static random access memory (“SRAM”), dynamic random access memory (“DRAM”) or ROM. The computing device 1902 may also include additional storage 1918, such as either removable storage or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some embodiments, the storage 1918 may be utilized to store data contents received from one or more other devices (e.g., server device 1910, other computing devices, or mobile devices 1904). For example, the storage 1918 may store accessory management settings, accessory settings, and user data associated with users affiliated with the mobile device 1902.

The computing device 1902 may also contain the communications interface 1914 that allows the computing device 1902 to communicate with a stored database, another computing device or server, user terminals, or other devices on the network(s) 1908. The computing device 1902 may also include I/O device(s) 1920, such as for enabling connection with a keyboard, a mouse, a pen, a voice input device, a touch input device, a display, speakers, a printer, etc. In some embodiments, the I/O devices(s) 1920 may be used to output an audio response or other indication as part of executing the response to a user request. The I/O device(s) can include one or more speakers 1946 or one or more microphones 1948.

The memory 1912 may include an operating system 1922 and one or more application programs or services for implementing the features disclosed herein, including a communications module 1924, a user interface module 1926, and a proximity module 1930. The proximity module further comprises a fingerprint module 1936 and a similarity module 1950. The proximity module 1930 can be configured to determine device proximity by comparing the similarity of a signal fingerprint retrieved from server device 1910 to a signal fingerprint generated by fingerprint module 1936. The device proximity can be determined by providing the retrieved signal fingerprint and the generated signal fingerprint to similarity module 1950 and receiving a proximity classification as output from the similarity module 1950. The similarity module can be a machine learning model that compares the set of signals for a first fingerprint to a set of signals in a second fingerprint In other examples, the similarity module can use one or more rules to determine if two fingerprints are similar. For instance, the similarity model can compare the sensor values of each fingerprint to determine if the difference between the magnitude of each of the sensor values is within a threshold value. The similarity model can use one or more of the cartesian distances, cosine similarity, or hamming distance between the set of signals in two fingerprints.

The communications module 1924 may comprise code that causes the processor(s) 1916 to generate instructions and messages, transmit data, or otherwise communicate with other entities. As described herein, the communications module 1924 may transmit messages via one or more network paths of network(s) 1908 (e.g., via a LAN associated with the monitored environment or an Internet WAN). For example, the communications module 1924 can communicate a sensor fingerprint to server device 1910. The communications module 1924 can provide information about signals received at mobile device 1902 to fingerprint module 1936 so that the fingerprint module can generate a signal fingerprint. The user interface module 1926 may comprise code that causes the processor(s) 1916 to present information corresponding to the location of a mobile device or proximate computing devices.

### 2. System for Detecting Device Proximity on a Server Device

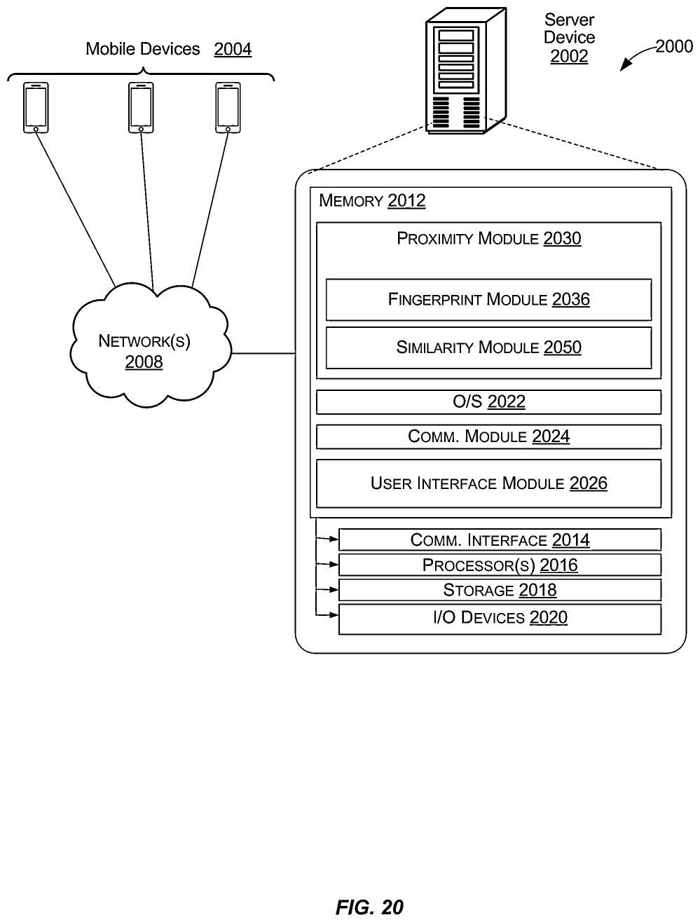

FIG. 20 is a simplified block diagram 2000 illustrating an example architecture of a system used to detect device proximity on a server device according to some embodiments. The diagram includes a server device 2002, one or more mobile devices 2004, and one or more network(s) 2008. Each of these elements depicted in FIG. 20 may be similar to one or more elements depicted in other figures described herein.

The mobile devices 2004 may be any suitable computing device (e.g., smartphone, smartwatch, laptop computer, tablet computer, etc.). In some embodiments, a mobile device may perform any one or more of the operations of mobile devices described herein. Depending on the type of mobile device and/or location of the accessory device the mobile device may be enabled to communicate using one or more network protocols (e.g., a Bluetooth connection, a Thread connection, a Zigbee connection, a Wi-Fi connection, etc.) and network paths over the network(s) 2008 (e.g., including a LAN or WAN), described further herein.

In some embodiments, the server device 2002 may be a computer system that comprises at least one memory, one or more processing units (or processor(s)), a storage unit, a communication device, and an I/O device. In some embodiments, the server device 2002 may perform any one or more of the operations of server devices described herein.

In some embodiments the one or more network(s) 2008 may include an Internet WAN and a LAN. For example, a router associated with a LAN may enable traffic from the LAN to be transmitted to the WAN, and vice versa. Mobile device 2002 or mobile devices 2004 may communicate with the WAN over a telecommunications network such as a broadband cellular network (e.g., 2G, 3G, 4G, 5G, or 6G telecommunications networks). In some embodiments, the server device 2002 may be external to the monitored environment, and thus, communicate with other devices over the WAN. For example, mobile devices 2004 can transmit to or retrieve signal fingerprints from the server device 2002. The signal fingerprints may be stored in the server device 2002, and the stored fingerprints may be associated with a geographic region, unique identifier, or a device identifier.

As described herein, server device 2002 may be representative of one or more computing devices connected to one or more of the network(s) 2008. The server device 2002 has at least one memory 2012, a communications interface 2014, one or more processing units (or processor(s) 2016, a storage unit 2018, and one or more Input/Output (I/O) device(s) 2020.

Turning to each element of computing device 2002 in further detail, the processor(s) 2016 may be implemented as appropriate in hardware, computer-executable instructions, firmware, or combinations thereof. Computer-executable instruction or firmware implementations of the processor(s) 2016 may include computer-executable or machine executable instructions written in any suitable programming language to perform the various functions described.

The memory 2012 may store program instructions that are loadable and executable on the processor(s) 2016, as well as data generated during the execution of these programs. Depending on the configuration and type of computing device 2002, the memory 2012 may be volatile (such as random access memory (“RAM”)) or non-volatile (such as read-only memory (“ROM”), flash memory, etc.). In some implementations, the memory 2012 may include multiple different types of memory, such as static random access memory (“SRAM”), dynamic random access memory (“DRAM”) or ROM. The computing device 2002 may also include additional storage 2018, such as either removable storage or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some embodiments, the storage 2018 may be utilized to store data contents received from one or more other devices (e.g., server device 2002, other computing devices, or mobile devices 2004). For example, the storage 2018 may store accessory management settings, accessory settings, and user data associated with users affiliated with the mobile device 2002.

The server device 2002 may also contain the communications interface 2014 that allows the computing device 2002 to communicate with a stored database, another computing device or server, user terminals, or other devices on the network(s) 2008. The server device 2002 may also include I/O device(s) 2020, such as for enabling connection with a keyboard, a mouse, a pen, a voice input device, a touch input device, a display, speakers, a printer, etc. In some embodiments, the I/O devices(s) 2020 may be used to output an audio response or other indication as part of executing the response to a user request. The I/O device(s) can include one or more speakers 2046 or one or more microphones 2048.

The memory 2012 may include an operating system 2022 and one or more application programs or services for implementing the features disclosed herein, including a communications module 2024, a user interface module 2026, and a proximity module 2030. The proximity module further comprises a fingerprint module 2036 and a similarity module 2050. The proximity module 2030 can be configured to determine device proximity by comparing the similarity of a signal fingerprint retrieved from mobile devices 2004 to a signal fingerprint generated by fingerprint module 2036 or a fingerprint stored in storage 2018. The device proximity can be determined by providing the retrieved signal fingerprint and the generated signal fingerprint to similarity module 2050 and receiving a proximity classification as output from the similarity module 2050. The similarity module can be a machine learning model that compares the set of signals for a first fingerprint to a set of signals in a second fingerprint. In some embodiments, the similarity module can use one or more rules to determine if two fingerprints are similar. For instance, the similarity model can compare the sensor values of each fingerprint to determine if the difference between the magnitude of each of the sensor values is within a threshold value. The similarity model can use one or more of the cartesian distances, cosine similarity, or hamming distance between the set of signals in two fingerprints.

The communications module 2024 may comprise code that causes the processor(s) 2016 to generate instructions and messages, transmit data, or otherwise communicate with other entities. As described herein, the communications module 2024 may transmit messages via one or more network paths of network(s) 2008 (e.g., via a LAN associated with the monitored environment or an Internet WAN). For example, the communications module 2024 can receive or transmit a sensor fingerprint between server device 2002 and mobile devices 2004. The communications module 2024 can receive information about signals received at mobile devices 2004 to fingerprint module 2036 so that the fingerprint module can generate a signal fingerprint. The user interface module 2026 may comprise code that causes the processor(s) 2016 to present information corresponding to the location of a mobile device or proximate computing devices.

### E. Use Cases

Determining device proximity can be used to locate a lost or unresponsive device that is not able to communicate its location directly to a searching device. In addition, the device proximity determination can be used to recommend an action to a mobile device. For example, the proximity determination can be used to recommend devices for pairing or for playback of media, such as audio or video.

### 1. Indirect Device Localization

Two mobile devices may not be able to directly communicate. The lack of communication can be because both devices do not support the same communication protocol, or one of the mobile devices may be powered off or broken. The two devices can indirectly communicate by sharing fingerprints through a third-party device such as a server device connected to a network (e.g., wide area network (WAN) or local area network (LAN)).

To indirectly locate a mobile device, a first mobile device can measure a sensor position and provide the sensor position to a third-party device such as a server device, which can be any network device available on a network accessible by the mobile devices. The sensor position can be provided at regular intervals or in response to an event. For example, the first mobile device can provide the sensor position in response to a low battery notification, leaving a wireless network, joining a wireless network, detecting movement, detecting no movement for a threshold amount of time, connecting to a paired device, disconnecting from a paired device, or pairing with a device. The regular intervals can be 5 minutes, 10 minutes, 15 minutes, 30 minutes, 1 hour, 2 hours, 6 hours, 12 hours, 24 hours, 36 hours, or 7 days.

A second mobile device can locate the first mobile device in response to a request. For example, a request to locate the second mobile device can be sent to the server device storing the second mobile device's fingerprints. The server device can store one or more fingerprints for the first mobile device in some embodiments. The request can cause the server device to determine if any of the stored fingerprints match the fingerprint generated by the first mobile device. Fingerprints can match if one or more of the sensor values in the fingerprints' sensor sets are within a threshold similarity as determined by a similarity function or if the total distance between the fingerprints is within a threshold. In addition, fingerprints may match if a threshold number of anchor identifiers are shared between fingerprints in addition to satisfying a distance or similarity threshold that is calculated using the sensor values. The server computer can provide the fingerprints generated by the first mobile device, to the second mobile device.

The fingerprints can be provided as input to a similarity model. The similarity model can run on the second mobile device or on a server device. The similarity model may run on a server device, and the proximity classification can be determined at the server. If the classification is determined at a server, the classification can be provided to the second mobile device via a network connection. Proximity classifications can include a determination that the fingerprints were recorded at the same location or a distance between the locations of the two fingerprints. The distance in a proximity classification can be a numerical distance (e.g., 25 meters) or a categorical classification (e.g., at the location, near the location, or far from the location). The similarity model can output the proximity classification for the two sensor positions (e.g., near, far, or an estimated distance (5 meters)). The similarity model may be on the server in some embodiments.

To identify matching fingerprints, the server device can compare each stored fingerprint to the fingerprints generated by the first mobile device, or the server can filter the stored fingerprints before the comparison. For example, each fingerprint may be associated with a global positioning system (GPS) location, and the comparison may only include stored fingerprints with a GPS location that is within a threshold distance of the GPS location for the fingerprints generated by the first mobile device. The threshold distance can be 1 meter, 5 meters, 15 meters, 20 meters, 50 meters, 100 meters, 200 meters, 500 meters, 1 kilometer, 1.5 kilometers, 5 kilometers, 10 kilometers, or 100 kilometers.

After the comparison, the server computer can provide the matching fingerprints to the second mobile device. The second mobile device can input the matching fingerprints to a similarity model to identify matching locations if the similarity model indicates that any of the fingerprints generated by the first mobile device are near a stored fingerprint. The location can be a GPS coordinate associated with the stored fingerprint that is near a fingerprint generated by the first mobile device. The second mobile device can travel to the location and obtain a second fingerprint. This second fingerprint can be fed to the similarity model to determine if the second mobile device is near the first mobile device. For example, the location can be a multistory building and the second mobile device can obtain a fingerprint for each floor. Once the similarity model indicates that the devices are near each other, the user of the second mobile device can search for the first mobile device. In some embodiments, the second mobile device can use ranging measurements with the signal sources to locate the precise location of the first mobile device.

### 2. Suggested Actions

Device location can be used to suggest actions to a first mobile device. The suggested actions can be actions that were taken by other mobile devices in a particular location. For example, mobile devices may turn on silent mode when entering a theater, and these devices can provide fingerprints, with actions, to a server. The first mobile device can use fingerprints to determine if the first mobile device is in a location where other devices have taken a particular action. Continuing the example, the first mobile device can suggest turning on silent mode if the mobile device determines that it is in an area where other devices commonly turn on silent mode. In addition, suggested actions are described in greater detail in section IV of the present application, and events that can trigger a prediction are described in section III.

To determine suggested actions, the first mobile device can provide fingerprints to the server while moving around throughout a day. The server can identify any stored fingerprints that are associated with the provided fingerprints. For example, the server can identify fingerprints that share at least one common anchor identifier with the provided fingerprint. In some embodiments, the fingerprints can include global positioning system (GPS) coordinates that can be compared to identify fingerprints that are associated with the provided fingerprints (e.g., within a threshold distance). Fingerprints can be captured at regular intervals or in response to actions. For instance, the actions can include interacting with an application, changing the settings of the mobile device, or a change in measured sensor values.

The first mobile device can input the matching fingerprints, and the fingerprint generated by the mobile device, as input to a similarity model. The matching fingerprints can include suggested actions, and, if the first mobile device is classified as near a location associated with a matching fingerprint, the mobile device can suggest an action to the first mobile device's user. For example, the first mobile device can present a notification via a graphical user interface on a display device of the first mobile device.

Suggested actions can include actions that were taken by a mobile device within a time period preceding a fingerprint. For example, the suggested actions can include any actions taken in a 30-minute time period before a fingerprint was generated. If the fingerprint includes sensor values measured during a time period, the fingerprint can include any actions taken by the mobile device during that time period. The time periods can be 5 minutes, 10 minutes, 15 minutes, 30 minutes, 1 hour, 2 hours, 6 hours, 12 hours, 24 hours, 36 hours, or 7 days. Actions can include changes to the mobile devices' settings, input provided to the mobile device, input provided to specific applications on the mobile device, joining a wireless network, or pairing with an electronic device.

For example, a mobile device in a hotel may detect multiple Bluetooth enabled streaming devices. However, the mobile device's user can struggle to determine which streaming device corresponds to her room. Instead of systematically testing each streaming device to determine which device corresponds to the room, the user can trigger the device to capture a fingerprint by opening the Bluetooth settings or interacting with a streaming service. The mobile device can capture a fingerprint and provide the fingerprint to a server.

The server can use the provided fingerprint to send a matching fingerprint to the mobile device. The matching fingerprint indicates that a previous mobile device, which was at the location at an earlier time period, paired with a particular streaming device. The mobile device can input the matching fingerprint, and the captured fingerprint, as input to a similarity model. The similarity model can classify the mobile device as near the mobile device that generated the matching fingerprint. As a result, the mobile device can suggest pairing to the particular streaming device to the user.

The suggested actions can include prompting a user to switch between playback devices. For example, a user may be streaming music from her mobile device to a speaker in her living room while studying on the couch. Without pausing the stream, the user may leave the couch and begin to prepare food in the kitchen.

### F. Techniques for Providing a Proximity Classification

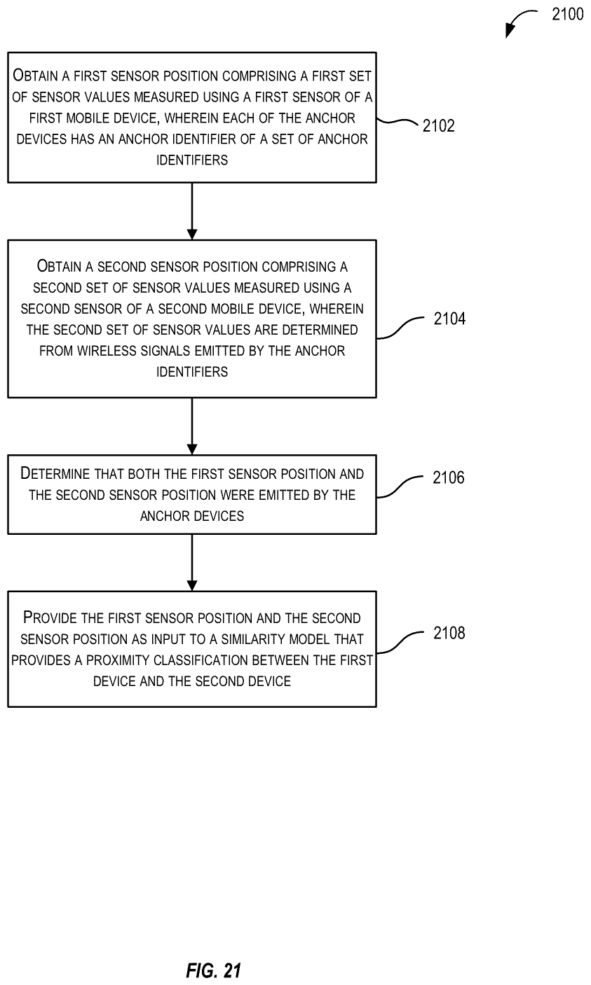

FIG. 21 is a flowchart of a method 2100 for providing a proximity classification according to some embodiments. Different devices may perform the steps of method 2100 in different embodiments. According to an example, one or more process blocks of FIG. 21 may be performed by a computing device, such as the first or second mobile device (e.g., a smartphone, a tablet device, a wearable device, and a laptop) or a network device (e.g., a server device).

At block 2102, a first sensor position (e.g., a first fingerprint) can be obtained. The sensor position can comprise a first set of sensor values measured using a first sensor of a mobile device. The first set of sensor values can be determined from wireless signals emitted by anchor devices. Each of the sensor values can be associated with the anchor devices that generated the sensor values by an anchor identifier of a set of anchor identifiers.

In some embodiments, the second mobile (e.g., mobile devices 1904, 2004) device can obtain the first sensor position through a request that is sent to a server device. The server device can use the request to search the device's memory for stored sensor positions that match information identifying the second sensor positions, and this search can return the first sensor position. In some embodiments, the server device can obtain the first sensor position by searching the device's memory for sensor positions that match information identifying the second sensor position, and this search can return the first sensor position. In some embodiments, the server device can provide all of the sensor positions stored in the server's memory.

The first sensor position (e.g., fingerprint) can include a global positioning system (GPS) address that was measured by the first mobile device. The first mobile device can associate the set of signal values that were used to generate the fingerprint with the GPS address. Generating the first sensor position can include removing one or more sensor values from the set of sensor values. The sensor values can correspond to one or more mobile devices. The sensor position can include information identifying actions performed by the first mobile device.

At block 2104, a second sensor position can be obtained. The second sensor position can comprise a second set of sensor values measured using a second sensor of a second mobile device (e.g., mobile device 1902, mobile devices 1904, mobile devices 2004). The second set of sensor values can be generated by the second mobile device from wireless signals emitted by the anchor identifiers. In some embodiments where the device proximity is determined by the second mobile device, obtaining the second sensor position can comprise generating the second sensor position. In embodiments where the device proximity is determined by the server device, the second sensor position can be obtained in response to a request from the second mobile device. The request can include the second sensor position or information identifying the second sensor position (e.g., an identifier). In some embodiments, the server device can provide all of the sensor positions stored in the server's memory.

Generating the second sensor position (e.g., fingerprint) by the second mobile device can include measuring a global positioning system (GPS) address and associating the set of signal values with the GPS address. Generating the second sensor position can include removing one or more sensor values from the set of sensor values by the second mobile device. The sensor values can correspond to one or more mobile devices. The sensor position can include information identifying one or more actions performed by the device that recorded the sensor values (e.g., the second mobile device) at the location where the sensor values were recorded.

At block 2106, that both the first sensor position and the second sensor position were determined using wireless signals emitted by the anchor devices can be determined. This determination can be performed at the second mobile device or at a server device (e.g., server device 1530, 1630, 1910 or 2002). In some embodiments, the anchor devices that are used to determine the first position can vary from the anchor devices used to determine the first position if at least some of the anchor devices overlap (e.g., one or more of the anchor devices are used to determine the first position and the second position). For example, the first position can be determined using anchor devices 1-5 and the second position can be determined using anchor devices 3-8.

At block 2108, the first sensor position and the second sensor position can be provided as input to a similarity model. This similarity function can execute on the second mobile device or on a server device (e.g., server device 1530, 1630, 1910 or 2002). The similarity model can provide a proximity classification between the first mobile device and the second mobile device. In some embodiments, examples of proximity classifications can include a distance between the first sensor position and the second sensor position. This distance can be a numerical distance or a categorical distance (e.g., at the location e.g., same cluster, near the location, or far from the location). The similarity model can be an algorithm or a machine learning model. The proximity classification can be determined using a probability or score that indicates whether the first mobile device and the second mobile device are near each other (e.g., in the same room, in the same building, within a threshold distance of each other).

The proximity classification can be determined by comparing the score or probability generated by the proximity model against a threshold. For example, the second mobile device can be assigned a proximity classification indicating that the second mobile device is a proximate device (e.g., is near the first mobile device) if the probability or score is above a threshold. The second mobile device can be assigned a proximity classification indicating that the second mobile device is a distant device (e.g., is far from the first mobile device) if the probability or score is above a threshold.

In embodiments where the proximity classification is determined on a server device, the proximity classification can be provided to the second mobile device. The second mobile device can use the proximity classification, which was calculated by the second mobile device or received from the server device, to take an action commensurate with the proximity classification. The commensurate action could include a notification indicating the proximity classification. The notification can be displayed on a display of the second mobile deice. In some embodiments, the notification can include an arrow pointing to the location of the first mobile device or a distance between the first mobile device and the second mobile device. The action(s) can include a suggestion action such as a notification identifying a device that the second mobile device can pair with.

### IX. Example Device

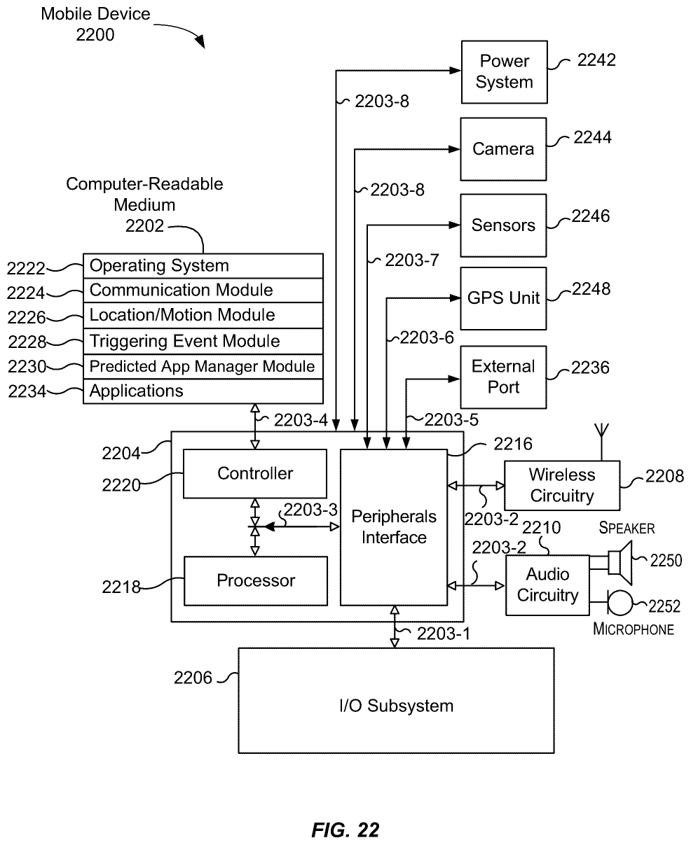

FIG. 22 is a block diagram of an example device 2200, which may be a mobile device. Device 2200 generally includes computer-readable medium 2202, a processing system 2204, an Input/Output (I/O) subsystem 2206, wireless circuitry 2208, and audio circuitry 2210 including speaker 2250 and microphone 2252. These components may be coupled by one or more communication buses or signal lines 2203. Device 2200 can be any portable mobile device, including a handheld computer, a tablet computer, a mobile phone, laptop computer, tablet device, media player, personal digital assistant (PDA), a key fob, a car key, an access card, a multi-function device, a mobile phone, a portable gaming device, a car display unit, or the like, including a combination of two or more of these items.

It should be apparent that the architecture shown in FIG. 22 is only one example of an architecture for device 2200, and that device 2200 can have more or fewer components than shown, or a different configuration of components. The various components shown in FIG. 22 can be implemented in hardware, software, or a combination of both hardware and software, including one or more signal processing and/or application specific integrated circuits.

Wireless circuitry 2208 is used to send and receive information over a wireless link or network to one or more other devices' conventional circuitry such as an antenna system, an RF transceiver, one or more amplifiers, a tuner, one or more oscillators, a digital signal processor, a CODEC chipset, memory, etc. Wireless circuitry 2208 can use various protocols, e.g., as described herein.

Wireless circuitry 2208 is coupled to processing system 2204 via peripherals interface 2216. Interface 2216 can include conventional components for establishing and maintaining communication between peripherals and processing system 2204. Voice and data information received by wireless circuitry 2208 (e.g., in speech recognition or voice command applications) is sent to one or more processors 2218 via peripherals interface 2216. One or more processors 2218 are configurable to process various data formats for one or more application programs 2234 stored on medium 2202.

Peripherals interface 2216 couple the input and output peripherals of the device to processor 2218 and computer-readable medium 2202. One or more processors 2218 communicate with computer-readable medium 2202 via a controller 2220. Computer-readable medium 2202 can be any device or medium that can store code and/or data for use by one or more processors 2218. Medium 2202 can include a memory hierarchy, including cache, main memory, and secondary memory.

Device 2200 also includes a power system 2242 for powering the various hardware components. Power system 2242 can include a power management system, one or more power sources (e.g., battery, alternating current (AC)), a recharging system, a power failure detection circuit, a power converter or inverter, a power status indicator (e.g., a light emitting diode (LED)), and any other components typically associated with the generation, management, and distribution of power in mobile devices.

In some embodiments, device 2200 includes a camera 2244. In some embodiments, device 2200 includes sensors 2246. Sensors 2246 can include accelerometers, compasses, gyrometers, pressure sensors, audio sensors, light sensors, barometers, and the like. Sensors 2246 can be used to sense location aspects, such as auditory or light signatures of a location.

In some embodiments, device 2200 can include a GPS receiver, sometimes referred to as a GPS unit 2248. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information. In other embodiments, device 2200 may be configured to identify GLONASS signals, or any other similar type of satellite navigational signal.

One or more processors 2218 run various software components stored in medium 2202 to perform various functions for device 2200. In some embodiments, the software components include an operating system 2222, a communication module (or set of instructions) 2224, a location module (or set of instructions) 2226, a triggering event module 2228, a predicted app manager module 2230, and other applications (or set of instructions) 2234, such as a car locator app and a navigation app.

Operating system 2222 can be any suitable operating system, including iOS, Mac OS, Darwin, RTXC, LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 2224 facilitates communication with other devices over one or more external ports 2236 or via wireless circuitry 2208 and includes various software components for handling data received from wireless circuitry 2208 and/or external port 2236. External port 2236 (e.g., USB, FireWire, Lightning connector, 60-pin connector, etc.) is adapted for coupling directly to other devices or indirectly over a network (e.g., the Internet, wireless LAN, etc.).

Location/motion module 2226 can assist in determining the current position (e.g., coordinates or other geographic location identifier) and motion of device 2200. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 2226 receives data from GPS unit 2248 and analyzes the signals to determine the current position of the mobile device. In some embodiments, location/motion module 2226 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 2208 and is passed to location/motion module 2226. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 2200 based on the position coordinates of the corresponding transmitters. Regardless of the specific location technology used, location/motion module 2226 receives information from which a location fix can be derived, interprets that information, and returns location information, such as geographic coordinates, latitude/longitude, or other location fix data.

Triggering event module 2228 can include various sub-modules or systems, e.g., as described herein with respect to FIG. 2A. Furthermore, predicted app manager module 2230 can include various sub-modules or systems, e.g., as described herein with respect to FIG. 3.

The one or more application programs 2234 on the mobile device can include any applications installed on the device 2200, including without limitation, a browser, address book, contact list, email, instant messaging, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating, and displaying graphical objects (including without limitation text, web pages, icons, digital images, animations, and the like) on a display surface. In another example, a timer module can be a software timer. The timer module can also be implemented in hardware. The time module can maintain various timers for any number of events.

The I/O subsystem 2206 can be coupled to a display system (not shown), which can be a touch-sensitive display. The display system displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 2206 can include a display and user input devices such as a keyboard, mouse, and/or track pad. In some embodiments, I/O subsystem 2206 can include a touch-sensitive display. A touch-sensitive display can also accept input from the user based on haptic and/or tactile contact. In some embodiments, a touch-sensitive display forms a touch-sensitive surface that accepts user input. The touch-sensitive display/surface (along with any associated modules and/or sets of instructions in medium 2202) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, the I/O subsystem can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 2200 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display, or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering and use of data available from various sources to improve prediction of users that a user may be interested in communicating with. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to predict users that a user may want to communicate with at a certain time and place. Accordingly, use of such personal information data included in contextual information enables people centric prediction of people a user may want to interact with at a certain time and place. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of people centric prediction services, the present technology can be configured to allow users to select to “opt in” or “opt out” of participation in the collection of personal information data during registration for services or anytime thereafter. In another example, users can select not to provide location information for recipient suggestion services. In yet another example, users can select to not provide precise location information, but permit the transfer of location zone information. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, users that a user may want to communicate with at a certain time and place may be predicted based on non-personal information data or a bare minimum amount of personal information, such as the content being requested by the device associated with a user, other non-personal information, or publicly available information.

Although the disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art. Where a conflict exists between the instant application and a reference provided herein, the instant application shall dominate.

1. A method comprising:
responsive to a trigger signal at an associated first time, generating a first location value using a first ranging session with one or more other devices;
storing the first location value in a memory;
tracking, using a motion sensor of a mobile device, motion of the mobile device to determine a present location relative to the first location value;
determining that a present location for the mobile device has changed by a threshold amount from the first location value since the associated first time;
responsive to the present location for the mobile device having changed by more than a predetermined threshold amount since the associated first time, generating a second location value using a second ranging session with the one or more other devices; and
storing the second location value in the memory.

2. The method of claim 1, wherein the second ranging session is further generated based on a screen of the mobile device facing towards a user.

3. The method of claim 1, wherein the second ranging session also requires that a screen of the mobile device is active.

4. The method of claim 1, further comprising:
determining a playback device for a streaming service based on the first location value or the second location value.

5. The method of claim 4, further comprising:
receiving a notification from a playback device instructing the mobile device to generate a third location value using a third ranging session for the mobile device.

6. The method of claim 1, wherein the motion sensor is an accelerometer of the mobile device.

7. The method of claim 1, wherein the mobile device delays generating the second location value until a screen of the mobile device is on.

8. The method of claim 1, wherein generating the second location value is delayed until the mobile device is stationary for a specified period of time.

9. The method of claim 8, further comprising:
determining that the mobile device is stationary by establishing a series of progressively smaller geo-fences to determine that the mobile device has stopped moving.

10. The method of claim 1, further comprising:
presenting a graphical user interface in response to the second location value.

11. The method of claim 10, wherein presenting the graphical user interface comprises:
determining one or more applications based on the second location value; and
presenting, by the graphical user interface, one or more graphical elements representing the one or more applications.

12. A mobile device, comprising:
one or more processors; and
a memory storing instructions that when executed by the one or more processors perform operations to:
responsive to a trigger signal at an associated first time, generate a first location value using a first ranging session with one or more other devices;
store the first location value in a memory;
track, using a motion sensor of the mobile device, motion of the mobile device to determine a present location relative to the first location value;
determine that a present location for the mobile device has changed by a threshold amount from the first location value since the associated first time;
responsive to the present location for the mobile device having changed by more than a predetermined threshold amount since the associated first time, generate a second location value using a second ranging session with the one or more other devices; and
store the second location value in the memory.

13. The mobile device of claim 12, wherein the second ranging session is further generated based on a screen of the mobile device facing towards a user.

14. The mobile device of claim 12, wherein the second ranging session also requires that a screen of the mobile device is active.

15. The mobile device of claim 12, further comprising:
determining a playback device for a streaming service based on the first location value or the second location value.

16. The mobile device of claim 15, further comprising:
receiving a notification from a playback device instructing the mobile device to generate a third location value using a third ranging session for the mobile device.

17. A non-transitory computer-readable medium storing instructions that when executed by one or more processors perform operations to:
responsive to a trigger signal at an associated first time, generate a first location value using a first ranging session with one or more other devices;
store the first location value in a memory;
track, using a motion sensor of a mobile device, motion of the mobile device to determine a present location relative to the first location value;
determine that a present location for the mobile device has changed by a threshold amount from the first location value since the associated first time;
responsive to the present location for the mobile device having changed by more than a predetermined threshold amount since the associated first time, generate a second location value using a second ranging session with the one or more other devices; and
store the second location value in the memory.

18. The non-transitory computer-readable medium of claim 13,
wherein the second ranging session is further generated based on a screen of the mobile device facing towards a user.

19. The non-transitory computer-readable medium of claim 13, wherein the second ranging session also requires that a screen of the mobile device is active.

20. The non-transitory computer-readable medium of claim 13, further comprising:
determining a playback device for a streaming service based on the first location value or the second location value.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)
